(19) United States
(12) Patent Application Publication
(10) Pub. No.: US 2012/0187762 A1
(43) Pub. Date: Jul. 26, 2012

(54) MULTI-CHANNEL PULSE WIDTH MODULATION SIGNAL GENERATING APPARATUS AND METHOD, AND LIGHT-EMITTING DIODE SYSTEM INCLUDING THE SAME

(76) Inventor: Wan-jung KIM, Suwon-si (KR)

(21) Appl. No.: 13/311,643

(22) Filed: Dec. 6, 2011

(30) Foreign Application Priority Data
Jan. 20, 2011 (KR) 10-2011-0005986

(51) Int. Cl. H02J 1/14

(52) U.S. Cl. 307/32

(57) ABSTRACT

A multi-channel PWM signal generating method includes receiving information having a pulse width and outputting a plurality of PWM signals based on the pulse width. The outputting includes outputting at least one pair of PWM signals that have a phase difference corresponding to a difference between an output period and the pulse width.

### CROSS-REFERENCE TO RELATED APPLICATIONS

This application claims priority to Korean Patent Application No. 10-2011-0005986, filed on Jan. 20, 2011, in the Korean Intellectual Property Office, the disclosure of which is incorporated by reference in its entirety herein.

### BACKGROUND

The inventive concept relates to a technique of driving a plurality of loads, and more particularly, to a multi-channel signal generating apparatus for generating a plurality of Pulse Width Modulation (PWM) signals for driving a plurality of loads.

In PWM, the average value of voltage (or current) fed to a load may be regulated by rapidly turning on and off a switch between a load and a supply. The longer the switch is on (e.g., a turn-on period) as compared to when the switch is off (e.g., a turn-off period), the higher the power supplied to the load is. When a plurality of loads is driven in a PWM scheme where the turn-on periods coincide, a current supplied to the loads may vary greatly during both a turn-on period and a turn-off period. As a result, a level of a voltage supplied to the loads fluctuates, thereby preventing a constant voltage from be supplied to the loads. This fluctuation may affect a normal operation when the loads require a constant voltage. Accordingly, there is a need for a scheme that can stably supply a constant voltage to a plurality of loads.

### SUMMARY

At least one embodiment of the inventive concept provides a multi-channel Pulse Width Modulation (PWM) signal generating method for generating a plurality of PWM signals for driving a plurality of loads such that turn-on timings of the plurality of loads are dispersed when the plurality of loads are driven in a PWM scheme.

At least one embodiment of the inventive concept provides a multi-channel PWM signal generating apparatus for generating a plurality of PWM signals for driving a plurality of loads such that turn-on timings of the plurality of loads are dispersed when the plurality of loads are driven in a PWM scheme.

At least one embodiment of the inventive concept provides a Light-Emitting Diode (LED) system including the multi-channel PWM signal generating apparatus for generating a plurality of PWM signals for driving a plurality of loads such that turn-on timings of the plurality of loads are dispersed when the plurality of loads are driven in a PWM scheme.

According to an exemplary embodiment of the inventive concept, a multi-channel PWM signal generating method includes receiving information including a pulse width and outputting a plurality of PWM signals based on the pulse width. The outputting includes outputting at least one pair of PWM signals that have a phase difference corresponding to a difference between an output period and the pulse width.

The outputting may include outputting the at least one pair of PWM signals and a second pair of PWM signals that have the phase difference therebetween and such that an on-pulse of a signal of the second pair is delayed relative to an on-pulse of the first pair. For example, the first pair and the second pair may be output in respective reference times different from each other such that an on-pulse of a PWM signal of the second pair is delayed relative to an on-pulse of a PWM signal of the first pair.

The outputting may include outputting a first PWM signal that is enabled during a time interval corresponding to the pulse width beginning at a first reference time and outputting a second PWM signal that has the phase difference from the first PWM signal.

The outputting may include outputting a third PWM signal that is enabled during a time interval corresponding to the pulse width beginning at a second reference time different from the first reference time.

The outputting may further include determining the second reference time based on the number of plurality of PWM signals.

The outputting may further include determining the second reference time based on the pulse width.

A difference between the first reference time and the second reference time may correspond to two times the pulse width when the pulse width is equal to or less than a threshold and correspond to the pulse width when the pulse width is greater than the threshold.

The threshold may be a value obtained by dividing the output period by the number of plurality of PWM signals.

The outputting may include outputting a fourth PWM signal that has the phase difference from the third PWM signal.

The multi-channel PWM signal generating method may further include receiving information including the output period.

According to an exemplary embodiment of the inventive concept, a multi-channel PWM signal generating apparatus includes a setting unit and a signal generator. The setting unit receives information including a pulse width. The signal generator outputs a plurality of PWM signals based on the pulse width. The signal generator outputs at least one pair of PWM signals that have a phase difference corresponding to a difference between an output period and the pulse width.

The signal generator may output the at least one pair of PWM signals and a second pair of PWM signals that have the phase difference therebetween and such that an on-pulse of a signal of the second pair is delayed relative to an on-pulse of the first pair.

The signal generator may include an enable signal generator for determining at least one reference time and a channel driver for outputting a first PWM signal that is enabled during a time interval corresponding to the pulse width beginning at a first reference time and a second PWM signal that has the phase difference from the first PWM signal.

The channel driver may output a third PWM signal that is enabled during a time interval corresponding to the pulse width beginning at a second reference time different from the first reference time.

The enable signal generator may determine the second reference time based on the number of plurality of PWM signals.

The enable signal generator may determine the second reference time based on the pulse width.

A difference between the first reference time and the second reference time may correspond to two times the pulse width when the pulse width is equal to or less than a threshold and correspond to the pulse width when the pulse width is greater than the threshold.

The threshold may be a value obtained by dividing the output period by the number of plurality of PWM signals.

The channel driver may output a fourth PWM signal that has the phase difference from the third PWM signal.

According to an exemplary embodiment of the inventive concept, an LED system includes a plurality of LED strings, a power unit, a LED driver, and a signal modulator. Each LED string is formed by connecting a plurality of LEDs in series. The power unit supplies power to the plurality of LED strings. The LED driver controls currents that flow through the plurality of LED strings. The LED driver may include a switching controller, a plurality of switches, and a signal modulator. The switching controller controls an output voltage of the power unit. The plurality of switches allow or block the currents from flowing through the plurality of LED strings. The signal modulator outputs a plurality of PWM signals to control an ON/OFF of the plurality of switches. The signal modulator may include a setting unit and a signal generator. The setting unit receives information including a pulse width. The signal generator outputs the plurality of PWM signals based on the pulse width. The signal generator outputs at least one pair of PWM signals that have a phase difference corresponding to a difference between an output period and the pulse width.

A driving system according to an exemplary embodiment of the invention includes a plurality of circuit loads, a power unit providing an output voltage to each circuit load, a plurality of switches, and a controller. Each corresponding one of the switches is connected between a respective one of the circuit loads and ground. The controller outputs a signal including an on-period and an off-period to each switch. During the on-period the corresponding load is activated and during the off-period the load is deactivated. The controller receives a pulse width and outputs the signals having an on-pulse with the pulse width and such that the first and second signals have a phase difference therebetween based on the received pulse width.

The controller may further receive a period and the controller may output the signals to have a period that is substantially the same as the received period and such that the phase difference is a difference between the period and the pulse width. The loads and the signals may number at least four, where the controller outputs the third and fourth signals to have a phase difference therebetween based on the received pulse width, and an on-pulse of the third signal is delayed relative to an on-pulse of the first signal by a delay period. The controller may store a threshold value, where the controller sets the delay period to twice the received pulse width when the pulse width is ≦the threshold value and sets the delay period to the pulse width otherwise. The signals may have substantially the same signal period and the threshold may be twice the signal period divided by the number of the signals.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a system for driving a plurality of loads in a Pulse Width Modulation (PWM) scheme according to an exemplary embodiment of the inventive concept;

FIGS. 2A and 2B illustrate exemplary waveform diagrams where 2 loads are driven by PWM signals that have a duty ratio (W₁/T) of 1/5;

FIGS. 3A and 3B illustrate exemplary waveform diagrams where 2 loads are driven by PWM signals that have a duty ratio (W₂/T) of 3/5;

FIGS. 4A and 4B illustrate exemplary waveform diagrams where 4 loads are driven by PWM signals that have a duty ratio (W₁/T) of 1/5;

FIGS. 5A and 5B illustrate exemplary waveform diagrams where 4 loads are driven by PWM signals that have a duty ratio (W₂/T) of 3/5;

FIGS. 6A and 6B illustrate exemplary waveform diagrams where 4 loads are driven by PWM signals that have a duty ratio (W₁/T) of 1/5;

FIGS. 7A and 7B illustrate exemplary waveform diagrams where 4 loads are driven by PWM signals that have a duty ratio (W₂/T) of 3/5;

FIGS. 8A and 8B illustrate exemplary waveform diagrams where a duty ratio of PWM signals for driving 2 loads is changed from 1/5 to 3/5;

FIGS. 9A and 9B illustrate exemplary waveform diagrams where a duty ratio of PWM signals for driving 4 loads is changed from 1/5 to 3/5;

FIG. 10 is a flowchart illustrating a multi-channel PWM signal generating method according to an exemplary embodiment of the inventive concept;

FIG. 11 is a flowchart illustrating a multi-channel PWM signal generating method according to an exemplary embodiment of the inventive concept;

FIG. 12 is a flowchart illustrating operations of FIG. 10 or 11, according to an exemplary embodiment of the inventive concept;

FIG. 13 is a flowchart illustrating operations of FIG. 10 or 11, according to an exemplary embodiment of the inventive concept;

FIG. 14 is a flowchart illustrating an operation of determining a reference time of FIG. 13, according to an exemplary embodiment of the inventive concept;

FIG. 15 is a flowchart illustrating an operation of determining a reference time of FIG. 13, according to an exemplary embodiment of the inventive concept;

FIG. 16 is a block diagram of a multi-channel PWM signal generating apparatus according to an exemplary embodiment of the inventive concept;

FIG. 17 is a block diagram of a signal generator of FIG. 16, according to an exemplary embodiment of the inventive concept;

FIG. 18 is a diagram of a Light-Emitting Diode (LED) system according to an exemplary embodiment of the inventive concept; and

FIG. 19 is a block diagram of a Liquid Crystal Display (LCD) device according to an exemplary embodiment of the inventive concept.

### DETAILED DESCRIPTION

Hereinafter, the inventive concept will be described in detail by explaining exemplary embodiments of the inventive concept with reference to the attached drawings.

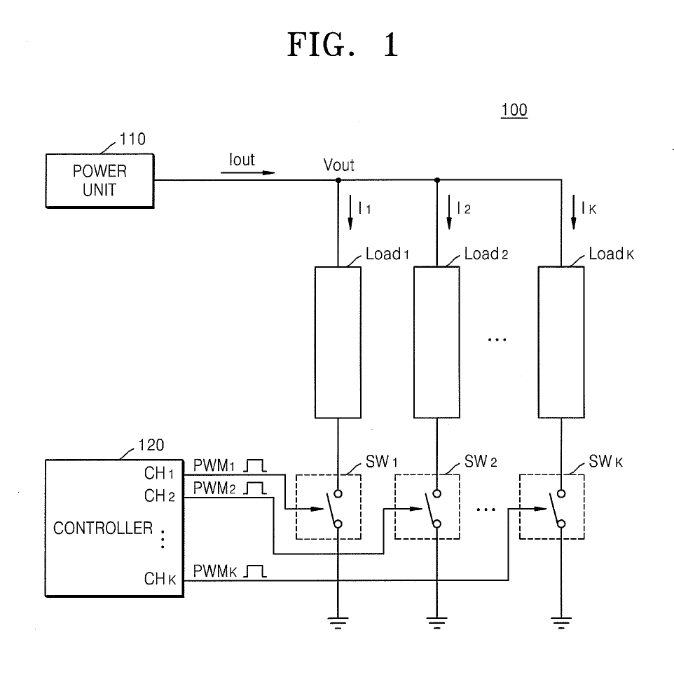

FIG. 1 is a block diagram of a system 100 for driving a plurality of loads Load₁ to Loadₖ in a Pulse Width Modulation (PWM) scheme. Referring to FIG. 1, the system 100 may include a power unit 110, a controller 120, the plurality of loads Load₁ to Loadₖ, and a plurality of switches SW₁ to SWₖ.

The power unit 110 may supply an output voltage Vout to the plurality of loads Load₁ to Loadₖ. The output voltage Vout may be a Direct Current (DC) voltage. The plurality of loads Load₁ to Loadₖ may be connected in parallel to each other so that the same output voltage Vout of the power unit 110 is applied to each of the plurality of loads Load₁ to Loadₖ. An output current Iout of the power unit 110 may be a sum of currents I₁ to Iₖ respectively supplied to the plurality of loads Load₁ to Loadₖ. Each of the plurality of loads Load₁ to Loadₖ may be a Light-Emitting Diode (LED) or a motor. The plurality of switches SW₁ to SWₖ may be periodically turned on or off in response to a plurality of PWM signals PWM₁ to PWM_{K}, respectively. Each of the plurality of switches SW₁ to SWₖ may form a current path by connecting one end of its corresponding load to the ground. Turning respective switches SW₁ to SWₖ on may turn (or activate) respective loads Load₁ to Loadₖ on, thereby consuming power thereon. The controller 120 may generate and output the plurality of PWM signals PWM₁ to PWM_{K} for controlling the plurality of switches SW₁ to SWₖ to form or cut off the current paths of the plurality of loads Load₁ to Loadₖ. The plurality of PWM signals PWM, to PWM_{K} may control ON/OFF timings of the plurality of switches SW₁ to SWₖ.

In one method, the plurality of loads Load₁ to Loadₖ is activated at the same time. In this method, the plurality of loads Load₁ to Loadₖ consume power by being turned on at the same time, so the power unit 110 has to instantaneously supply a large amount of the current Iout. Since this instantaneous variation of the current Iout is great, it is difficult for the DC voltage Vout supplied to the plurality of loads Load₁ to Loadₖ to be stably maintained. Thus, in the simultaneous driving method, the instability of the system 100 that operates with a predetermined level of a constant voltage increases.

In another method, the plurality of loads Load₁ to Loadₖ is driven by dispersing turn-on timings or activation timings of the plurality of loads Load₁ to Loadₖ. In this time difference driving method, as compared with the simultaneous driving method, the burden of the power unit 110 for instantaneously supplying current may be reduced by varying an activation time or a turn-on time of each of the plurality of loads Load₁ to Loadₖ. Various driving methods for activating the plurality of loads Load₁ to Loadₖ with time differences are presented herein according to exemplary embodiments of the inventive concept.

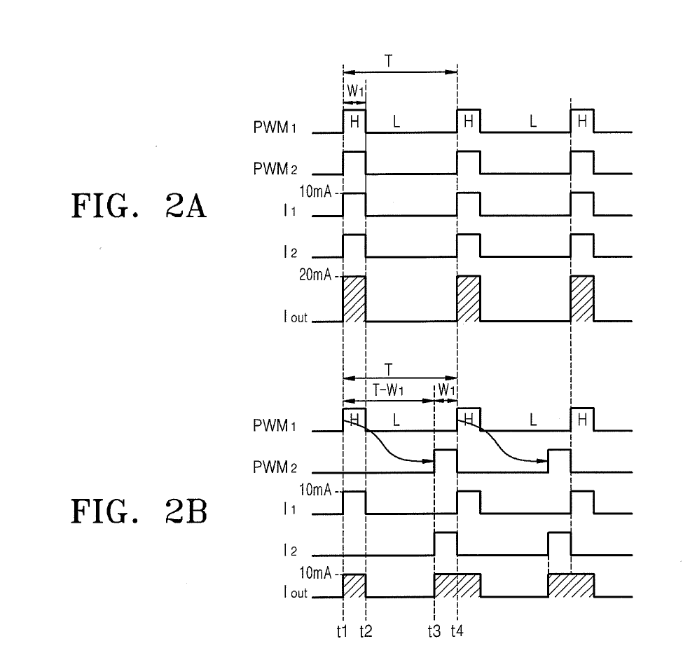

Hereinafter, an example where the simultaneous driving method being applied to the system 100 of FIG. 1 is compared against driving methods according to exemplary embodiments of the inventive concept being applied to the system 100 of FIG. 1 with reference to FIGS. 2 to 9.

FIGS. 2A and 2B illustrate exemplary waveform diagrams of an example where 2 loads are driven by PWM signals that have a duty ratio (W₁/T) of 1/5. FIG. 2A illustrates the example where the simultaneous driving method is applied, and FIG. 2B illustrates an example where a driving method according to an exemplary embodiment of the inventive concept is applied. Hereinafter, it is assumed for convenience of description that first and second currents I₁ and I₂ that flow when first and second loads Load₁ and Load₂ are turned on (or activated) are 10 mA. However, embodiments of the inventive concept are not limited to load currents of any particular magnitude.

Referring to FIG. 2A, each of first and second PWM signals PWM₁ and PWM₂ output from the controller 120 has an output period T and a pulse width W₁. There is no phase difference between the first and second PWM signals PWM₁ and PWM₂. Since waveforms of the control signals, namely, the first and second PWM signals PWM1 and PWM2, for respectively turning the first and second loads Load₁ and Load₂ on are the same, waveforms of the first and second currents I₁ and I₂ that respectively flow through the first and second loads Load₁ and Load₂ are also the same. For example, the first and second currents I₁ and I₂ that respectively flow through the first and second loads Load₁ and Load₂ can be 10 mA in a time interval between t1 and t2 and 0 mA in a time interval between t2 and t4. Thus, the output current Iout of the power unit 110 is 20 mA in the time interval between t1 and t2 and 0 mA in the time interval between t2 and t4. A variation of the output current Iout during a single output period T is +20 mA at t1 and −20 mA at t2. As a result, the maximum magnitude of the variation of the output current Iout during the single output period T is 20 mA.

Referring to FIG. 2B, each of the first and second PWM signals PWM₁ and PWM₂ output from the controller 120 has the output period T and the pulse width W₁. In an embodiment of the inventive concept, there is a phase difference between the first and second PWM signals PWM₁ and PWM₂, which corresponds to T−W₁ (e.g., a difference between the output period T and the pulse width W₁). Since there is a phase difference corresponding to T−W₁ between waveforms of the control signals, namely, the first and second PWM signals PWM1 and PWM2, for respectively turning the first and second loads Load₁ and Load₂ on, there is also a phase difference corresponding to T−W₁ between waveforms of the first and second currents I₁ and I₂ that respectively flow through the first and second loads Load₁ and Load₂. For example, the first current I₁ that flows through the first load Load₁ is 10 mA in the time interval between t1 and t2 and 0 mA in the time interval between t2 and t4. Further, the second current I₂ that flows through the second load Load₂ is 0 mA in a time interval between t1 and t3 and 10 mA in a time interval between t3 and t4. Each of the time intervals between t1 and t2 and the time intervals between t3 and t4 correspond to the pulse width W₁. The output current Iout of the power unit 110 is 10 mA in the time interval between t1 and t2, 0 mA in a time interval between t2 and t3, and 10 mA in the time interval between t3 and t4. Thus, a variation of the output current Iout of the power unit 110 in the time interval between t1 and t4 is +10 mA at t1 and t3 and −10 mA at t2. As a result, the maximum magnitude of the variation of the output current Iout during the single output period T is 10 mA. Thus, the maximum magnitude of the variation of the output current Iout is reduced by 50% as compared with the example of FIG. 2A where the simultaneous driving method is applied. Here, t1 denotes a first reference time, which may be a reference time or a start time for generating the first and second PWM signals PWM₁ and PWM₂. For example, the first PWM signal PWM₁ may be enabled at the first reference time t1, and the second PWM signal PWM₂ may be delayed by T−W₁ from the first reference time t1 and enabled. As a result, the second PWM signal PWM₂ may be delayed by T−W₁ from the first PWM signal PWM₁.

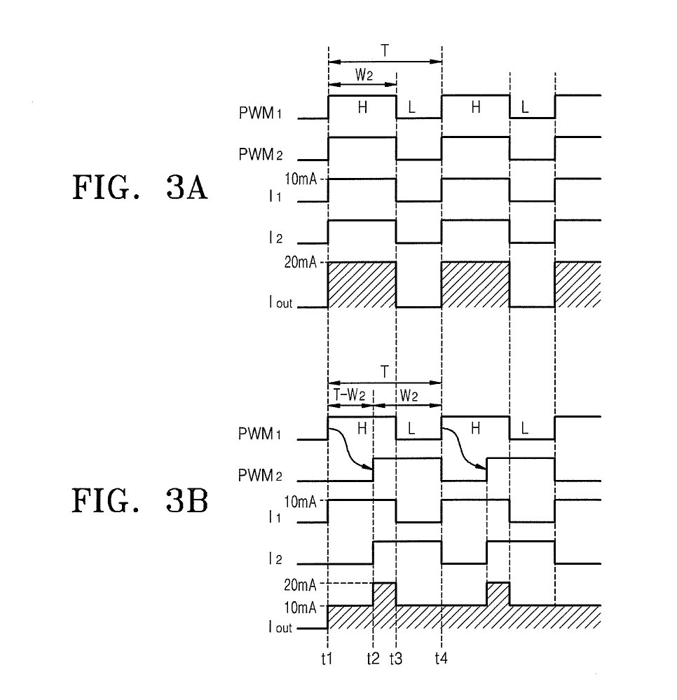

FIGS. 3A and 3B illustrate exemplary waveform diagrams where 2 loads are driven by PWM signals that have a duty ratio (W₂/T) of 3/5. FIG. 3A illustrates an example where the simultaneous driving method is applied, and FIG. 3B illustrates an example where a driving method according to an exemplary embodiment of the inventive concept is applied. Hereinafter, it is assumed for convenience of description that the first and second currents I₁ and I₂ that flow when the first and second loads Load₁ and Load₂ are turned on (or activated) are 10 mA.

Referring to FIG. 3A, each of first and second PWM signals PWM₁ and PWM₂ output from the controller 120 has an output period T and a pulse width W₂. There is no phase difference between the first and second PWM signals PWM₁ and PWM₂. Since waveforms of the control signals, namely, the first and second PWM signals PWM1 and PWM2, for respectively turning the first and second loads Load₁ and Load₂ on are the same, waveforms of the first and second currents I₁ and I₂ that respectively flow through the first and second loads Load₁ and Load₂ are also the same. For example, the first and second currents I₁ and I₂ that respectively flow through the first and second loads Load₁ and Load₂ are 10 mA in a time interval between t1 and t3 and 0 mA in a time interval between t3 and t4. Thus, the output current Iout of the power unit 110 is 20 mA in the time interval between t1 and t3 and 0 mA in the time interval between t3 and t4. A variation of the output current Iout in the time interval between t1 and t4 is +20 mA at t1 and −20 mA at t3. As a result, the maximum magnitude of the variation of the output current Iout during the single output period T is 20 mA.

Referring to FIG. 3B, each of the first and second PWM signals PWM₁ and PWM₂ output from the controller 120 has the output period T and the pulse width W₂. There is a phase difference between the first and second PWM signals PWM₁ and PWM₂, which corresponds to T−W₂ (e.g., a difference between the output period T and the pulse width W₂). Since there is a phase difference corresponding to T−W₂ between waveforms of the control signals, namely, the first and second PWM signals PWM1 and PWM2, for respectively turning the first and second loads Load₁ and Load₂ on, there is also a phase difference corresponding to T−W₂ between waveforms of the first and second currents I₁ and I₂ that respectively flow through the first and second loads Load₁ and Load₂. For example, the first current I₁ that flows through the first load Load₁ is 10 mA in the time interval between t1 and t3 and 0 mA in the time interval between t3 and t4. The second current I₂ that flows through the second load Load₂ is 0 mA in a time interval between t1 and t2 and 10 mA in a time interval between t2 and t4. Each of the time intervals between t1 and t3 and the time interval between t2 and t4 corresponds to the pulse width W₂. The output current Iout of the power unit 110 is 10 mA in the time interval between t1 and t2, 20 mA in a time interval between t2 and t3, and 10 mA in the time interval between t3 and t4. Thus, a variation of the output current Iout of the power unit 110 in the time interval between t1 and t4 is +10 mA at t1 and t2 and −10 mA at t3. As a result, the maximum magnitude of the variation of the output current Iout during the single output period T is 10 mA. Thus, the maximum magnitude of the variation of the output current Iout is reduced by 50% as compared with the example of FIG. 3A where the simultaneous driving method is applied. Here, t1 denotes the first reference time, which may be a reference time or a start time for generating the first and second PWM signals PWM₁ and PWM₂. For example, the first PWM signal PWM₁ may be enabled at the first reference time t1, and the second PWM signal PWM₂ may be delayed by T−W₂ from the first reference time t1 and enabled. As a result, the second PWM signal PWM₂ may be delayed by T−W₂ from the first PWM signal PWM₁.

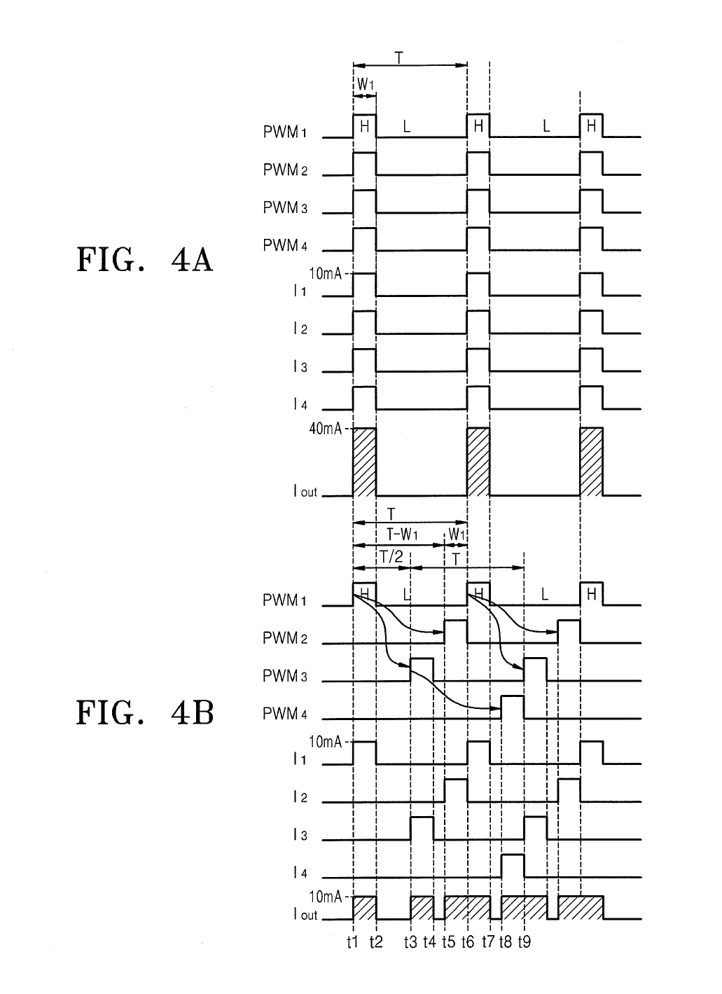

FIGS. 4A and 4B illustrate exemplary waveform diagrams where 4 loads are driven by PWM signals that have a duty ratio (W₁/T) of 1/5. FIG. 4A illustrates an example where the simultaneous driving method is applied, and FIG. 4B illustrates an example where a driving method according to an exemplary embodiment of the inventive concept is applied. Hereinafter, it is assumed for convenience of description that first to fourth currents I₁ to I₄ that flow when first to fourth loads Load₁ to Load₄ are turned on (or activated) are 10 mA.

Referring to FIG. 4A, each of first to fourth PWM signals PWM₁ to PWM₄ output from the controller 120 has an output period T and a pulse width W₁. There is no phase difference between any two of the first to fourth PWM signals PWM₁ to PWM₄. Since waveforms of the control signals, namely, first to fourth PWN signals PWM1 to PWM4, for respectively turning the first to fourth loads Load₁ to Load₄ on are the same, waveforms of the first to fourth currents I₁ to I₄ that respectively flow through the first to fourth loads Load₁ to Load₄ are also the same. For example, the first to fourth currents I₁ to I₄ that respectively flow through the first to fourth loads Load₁ to Load₄ are 10 mA in a time interval between t1 and t2 and 0 mA in a time interval between t2 and t6. The output current Iout of the power unit 110 is 40 mA in the time interval between t1 and t2 and 0 mA in the time interval between t2 and t6. Thus, a variation of the output current Iout in a time interval between t1 and t6 is +40 mA at t1 and −40 mA at t2. As a result, the maximum magnitude of the variation of the output current Iout during the single output period T is 40 mA.

Referring to FIG. 4B, each of the first to fourth PWM signals PWM₁ to PWM₄ output from the controller 120 has the output period T and the pulse width W₁. The first to fourth PWM signals PWM₁ to PWM₄ are enabled at times different from each other. Thus, the first to fourth PWM signals PWM₁ to PWM₄ have phases different from each other. There is a phase difference between the first and second PWM signals PWM₁ and PWM₂, which corresponds to a difference between the output period T and the pulse width W₁. Since there is a phase difference corresponding to T−W₁ between waveforms of the control signals, namely, the first and second PWM signals PWM1 and PWM2, for respectively turning the first and second loads Load₁ and Load₂ on, there is also a phase difference corresponding to T−W₁ between waveforms of the first and second currents I₁ and I₂ that respectively flow through the first and second loads Load₁ and Load₂. For example, the first current I₁ that flows through the first load Load₁ is 10 mA in the time interval between t1 and t2 and 0 mA in the time interval between t2 and t6. The second current I₂ that flows through the second load Load₂ is 0 mA in a time interval between t1 and t5 and 10 mA in a time interval between t5 and t6. Each of the time intervals between t1 and t2 and the time intervals between t5 and t6 correspond to the pulse width W₁. In addition, there is a phase difference between the third and fourth PWM signals PWM₃ and PWM₄, which corresponds to a difference between the output period T and the pulse width W₁. Since there is a phase difference corresponding to T−W₁ between waveforms of the control signals, namely, the third and fourth PWM signals PWM3 and PWM4, for respectively turning the third and fourth loads Load₃ and Load₄ on, there is also a phase difference corresponding to T−W₁ between waveforms of the third and fourth currents I₃ and I₄ that respectively flow through the third and fourth loads Load₃ and Load₄. For example, the third current I₃ that flows through the third load Load₃ is 10 mA in a time interval between t3 and t4 and 0 mA in a time interval between t4 and t9. The fourth current I₄ that flows through the fourth load Load₄ is 0 mA in a time interval between t3 and t8 and 10 mA in a time interval between t8 and t9. Each of the time intervals between t3 and t4 and the time intervals between t8 and t9 correspond to the pulse width W₁. The output current Iout of the power unit 110 is 10 mA in the time interval between t1 and t2, 0 mA in a time interval between t2 and t3, 10 mA in the time interval between t3 and t4, 0 mA in a time interval between t4 and t5, 10 mA in a time interval between t5 and t7, 0 mA in a time interval between t7 and t8, and 10 mA in the time interval between t8 and t9. Thus, a variation of the output current Iout of the power unit 110 in the time interval between t3 and t9 is +10 mA at t3, t5, and t8 and −10 mA at t4 and t7. As a result, the maximum magnitude of the variation of the output current Iout during the single output period T is 10 mA. Thus, the maximum magnitude of the variation of the output current Iout is reduced by 75% as compared with the example of FIG. 4A where the simultaneous driving method is applied. Here, t1 denotes the first reference time, which may be a reference time or a start time for generating the first and second PWM signals PWM₁ and PWM₂. For example, the first PWM signal PWM₁ may be enabled at the first reference time t1, and the second PWM signal PWM₂ may be delayed by T−W₁ from the first reference time t1 and enabled. As a result, the second PWM signal PWM₂ may be delayed by T−W₁ from the first PWM signal PWM₁.

In addition, t3 denotes a second reference time, which may be a reference time or a start time for generating the third and fourth PWM signals PWM₃ and PWM₄. For example, the third PWM signal PWM₃ may be enabled at the second reference time t3, and the fourth PWM signal PWM₄ may be delayed by T−W₁ from the second reference time t3 and enabled. As a result, the fourth PWM signal PWM₄ may be delayed by T−W₁ from the third PWM signal PWM₃.

A difference between the first reference time t1 and the second reference time t3 may be arbitrarily determined. FIG. 4B illustrates an example where the difference between the first reference time t1 and the second reference time t3 is half of a period (e.g., T/2). For example, the second reference time t3 is delayed by T/2 from the first reference time t1. In alternate embodiments, this difference may be less than half a period or greater than half a period.

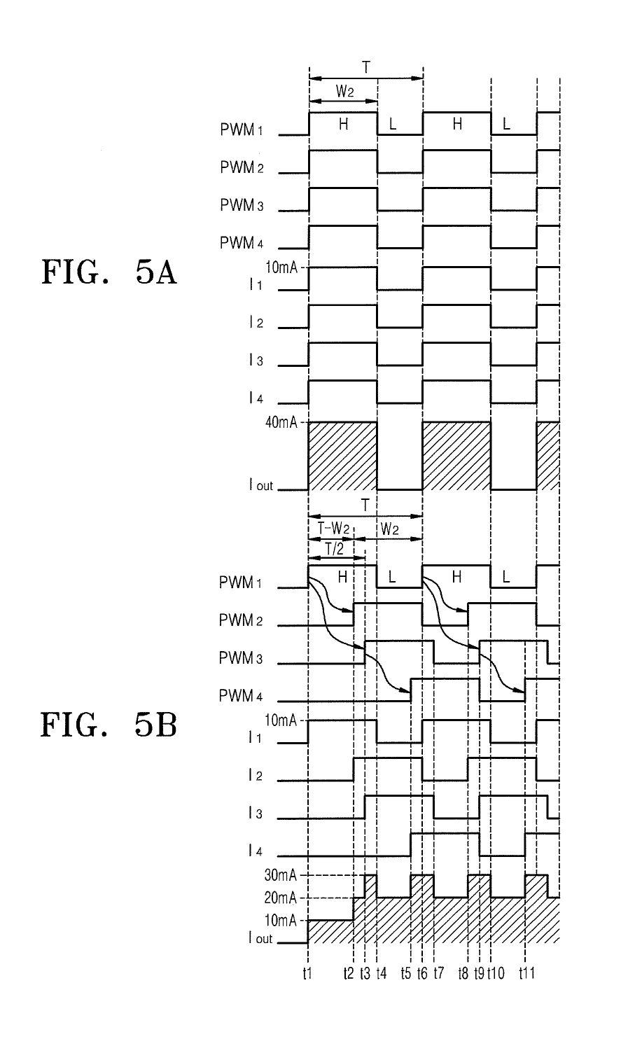

FIGS. 5A and 5B illustrate exemplary waveform diagrams where 4 loads are driven by PWM signals that have a duty ratio (W₂/T) of 3/5. FIG. 5A illustrates an example where the simultaneous driving method is applied, and FIG. 5B illustrates an example where a driving method according to an exemplary embodiment of the inventive concept is applied. Hereinafter, it is assumed for convenience of description that first to fourth currents I₁ to I₄ that flow when first to fourth loads Load₁ to Load₄ are turned on (or activated) are 10 mA.

Referring to FIG. 5A, each of first to fourth PWM signals PWM₁ to PWM₄ output from the controller 120 has an output period T and a pulse width W₂. There is no phase difference between any two of the first to fourth PWM signals PWM₁ to PWM₄. Since waveforms of the control signals, namely, first to fourth PWN signals PWM1 to PWM4, for respectively turning the first to fourth loads Load₁ to Load₄ on are the same, waveforms of the first to fourth currents I₁ to I₄ that respectively flow through the first to fourth loads Load₁ to Load₄ are also the same. For example, the first to fourth currents I₁ to I₄ that respectively flow through the first to fourth loads Load₁ to Load₄ are 10 mA in a time interval between t1 and t4 and 0 mA in a time interval between t4 and t6. The output current Iout of the power unit 110 is 40 mA in the time interval between t1 and t4 and 0 mA in the time interval between t4 and t6. Thus, a variation of the output current Iout in a time interval between t1 and t6 is +40 mA at t1 and −40 mA at t4. As a result, the maximum magnitude of the variation of the output current Iout during the single output period T is 40 mA.

Referring to FIG. 5B, each of the first to fourth PWM signals PWM₁ to PWM₄ output from the controller 120 has the output period T and the pulse width W₂. The first to fourth PWM signals PWM₁ to PWM₄ are enabled at times different from each other. Thus, the first to fourth PWM signals PWM₁ to PWM₄ have phases different from each other. There is a phase difference between the first and second PWM signals PWM₁ and PWM₂, which corresponds to T−W₂ (e.g., a difference between the output period T and the pulse width W₂). Since there is a phase difference corresponding to T−W₂ between waveforms of the control signals, namely, the first and second PWM signals PWM1 and PWM2, for respectively turning the first and second loads Load₁ and Load₂ on, there is also a phase difference corresponding to T−W₂ between waveforms of the first and second currents I₁ and I₂ that respectively flow through the first and second loads Load₁ and Load₂. For example, the first current I₁ that flows through the first load Load₁ is 10 mA in the time interval between t1 and t4 and 0 mA in the time interval between t4 and t6. The second current I₂ that flows through the second load Load₂ is 0 mA in a time interval between t1 and t2 and 10 mA in a time interval between t2 and t6. Each of the time intervals between t1 and t4 and the time intervals between t2 and t6 corresponds to the pulse width W₂. In addition, there is a phase difference between the third and fourth PWM signals PWM₃ and PWM₄, which corresponds to T−W₂ (e.g., a difference between the output period T and the pulse width W₂). Since there is a phase difference corresponding to T−W₂ between waveforms of the control signals, namely, the third and fourth PWM signals PWM3 and PWM4, for respectively turning the third and fourth loads Load₃ and Load₄ on, there is also a phase difference corresponding to T−W₂ between waveforms of the third and fourth currents I₃ and I₄ that respectively flow through the third and fourth loads Load₃ and Load₄. For example, the third current I₃ that flows through the third load Load₃ is 10 mA in a time interval between t3 and t7 and 0 mA in a time interval between t7 and t9. The fourth current I₄ that flows through the fourth load Load₄ is 0 mA in a time interval between t3 and t5 and 10 mA in a time interval between t5 and t9. Each of the time intervals between t3 and t7 and the time intervals between t5 and t9 corresponds to the pulse width W₂. The output current Iout of the power unit 110 is 10 mA in the time interval between t1 and t2, 20 mA in a time interval between t2 and t3, 30 mA in a time interval between t3 and t4, 20 mA in a time interval between t4 and t5, 30 mA in a time interval between t5 and t7, 20 mA in a time interval between t7 and t8, 30 mA in a time interval between t8 and t10, and 20 mA in a time interval between t10 and t11. Thus, a variation of the output current Iout of the power unit 110 in a time interval between t1 and t11 is +10 mA at t1, t2, t3, t5, and t8 and −10 mA at t4, t7, and t10. As a result, the maximum magnitude of the variation of the output current Iout during the single output period T is 10 mA. Thus, the maximum magnitude of the variation of the output current Iout is reduced by 75% as compared with the example of FIG. 5A where the simultaneous driving method is applied. Here, t1 denotes the first reference time, which may be a reference time or a start time for generating the first and second PWM signals PWM₁ and PWM₂. For example, the first PWM signal PWM₁ may be enabled at the first reference time t1, and the second PWM signal PWM₂ may be delayed by T−W₂ from the first reference time t1 and enabled. As a result, the second PWM signal PWM₂ may be delayed by T−W₂ from the first PWM signal PWM₁.

In addition, t3 denotes the second reference time, which may be a reference time or a start time for generating the third and fourth PWM signals PWM₃ and PWM₄. For example, the third PWM signal PWM₃ may be enabled at the second reference time t3, and the fourth PWM signal PWM₄ may be delayed by T−W₂ from the second reference time t3 and enabled. As a result, the fourth PWM signal PWM₄ may be delayed by T−W₂ from the third PWM signal PWM₃.

A difference between the first reference time t1 and the second reference time t3 may be arbitrarily determined. For example, the difference between the first reference time t1 and the second reference time t3 may be determined based on the number K of PWM signals. For example, when the number K of PWM signals is an even number, the difference between the first reference time t1 and the second reference time t3 may be determined as a value obtained by dividing two times the output period T by the number K of PWM signals. When the number K of PWM signals is an odd number, the difference between the first reference time t1 and the second reference time t3 may be determined as a value obtained by dividing two times the output period T by a value obtained by adding 1 to the number K of PWM signals. Since the number K of PWM signals in FIG. 5B is 4, the difference between the first reference time t1 and the second reference time t3 is half of a period (e.g., T/2). For example, the second reference time t3 is delayed by T/2 from the first reference time t1. The second reference time t3 is constant regardless of the pulse width W₂.

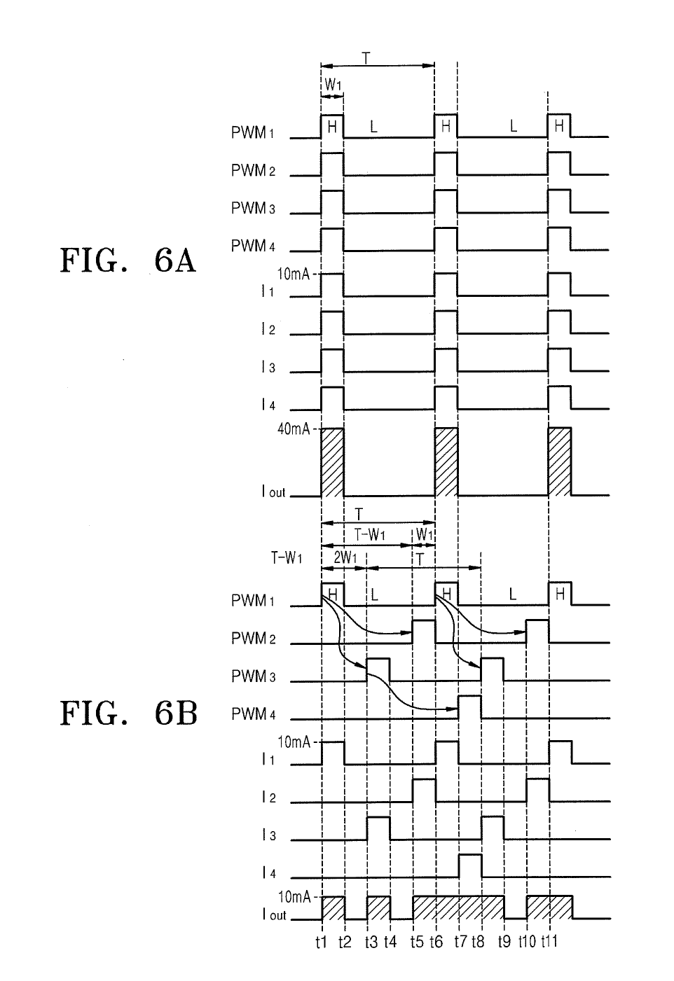

FIGS. 6A and 6B illustrate exemplary waveform diagram where 4 loads are driven by PWM signals that have a duty ratio (W₁/T) of 1/5. FIG. 6A illustrates an example where the simultaneous driving method is applied, and FIG. 6B illustrates an example where a driving method according to an exemplary embodiment of the inventive concept is applied. Hereinafter, it is assumed for convenience of description that first to fourth currents I₁ to I₄ that flow when first to fourth loads Load₁ to Load₄ are turned on (or activated) are 10 mA.

Referring to FIG. 6A, each of first to fourth PWM signals PWM₁ to PWM₄ output from the controller 120 has an output period T and a pulse width W₁. There is no phase difference between any two of the first to fourth PWM signals PWM₁ to PWM₄. Since waveforms of the control signals, namely, first to fourth PWM signals PWM1 to PWM4, for respectively turning the first to fourth loads Load₁ to Load₄ on are the same, waveforms of the first to fourth currents I₁ to I₄ that respectively flow through the first to fourth loads Load₁ to Load₄ are also the same. For example, the first to fourth currents I₁ to I₄ that respectively flow through the first to fourth loads Load₁ to Load₄ are 10 mA in a time interval between t1 and t2 and 0 mA in a time interval between t2 and t6. The output current Iout of the power unit 110 is 40 mA in the time interval between t1 and t2 and 0 mA in the time interval between t2 and t6. Thus, a variation of the output current Iout in a time interval between t1 and t6 is +40 mA at t1 and −40 mA at t2. As a result, the maximum magnitude of the variation of the output current Iout during the single output period T is 40 mA.

Referring to FIG. 6B, each of the first to fourth PWM signals PWM₁ to PWM₄ output from the controller 120 has the output period T and the pulse width W₁. The first to fourth PWM signals PWM₁ to PWM₄ are enabled at times different from each other. Thus, the first to fourth PWM signals PWM₁ to PWM₄ have phases different from each other. There is a phase difference between the first and second PWM signals PWM₁ and PWM₂, which corresponds to a difference between the output period T and the pulse width W₁. Since there is a phase difference corresponding to T−W₁ between waveforms of the control signals, namely, the first and second PWM signals PWM1 and PWM2, for respectively turning the first and second loads Load₁ and Load₂ on, there is also a phase difference corresponding to T−W₁ between waveforms of the first and second currents I₁ and I₂ that respectively flow through the first and second loads Load₁ and Load₂. For example, the first current I₁ that flows through the first load Load₁ is 10 mA in the time interval between t1 and t2 and 0 mA in the time interval between t2 and t6. The second current I₂ that flows through the second load Load₂ is 0 mA in a time interval between t1 and t5 and 10 mA in a time interval between t5 and t6. Each of the time intervals between t1 and t2 and the time intervals between t5 and t6 corresponds to the pulse width W₁. In addition, there is a phase difference between the third and fourth PWM signals PWM₃ and PWM₄, which corresponds to a difference between the output period T and the pulse width W₁. Since there is a phase difference corresponding to T−W₁ between waveforms of the control signals, namely, the third and fourth PWM signals PWM3 and PWM4, for respectively turning the third and fourth loads Load₃ and Load₄ on, there is also a phase difference corresponding to T−W₁ between waveforms of the third and fourth currents I₃ and I₄ that respectively flow through the third and fourth loads Load₃ and Load₄. For example, the third current I₃ that flows through the third load Load₃ is 10 mA in a time interval between t3 and t4 and 0 mA in a time interval between t4 and t8. The fourth current I₄ that flows through the fourth load Load₄ is 0 mA in a time interval between t3 and t7 and 10 mA in a time interval between t7 and t8. Each of the time intervals between t3 and t4 and the time intervals between t7 and t8 corresponds to the pulse width W₁. The output current Iout of the power unit 110 is 10 mA in the time interval between t1 and t2, 0 mA in a time interval between t2 and t3, 10 mA in the time interval between t3 and t4, 0 mA in a time interval between t4 and t5, 10 mA in a time interval between t5 and t9, 0 mA in a time interval between t9 and t10, and 10 mA in a time interval between t10 and t11. Thus, a variation of the output current Iout of the power unit 110 is +10 mA at t1, t3, t5, and t10 and −10 mA at t2, t4, and t9. As a result, the maximum magnitude of the variation of the output current Iout during the single output period T is 10 mA. Thus, the maximum magnitude of the variation of the output current Iout is reduced by 75% as compared with the example of FIG. 6A where the simultaneous driving method is applied.

Here, t1 denotes the first reference time, which may be a reference time or a start time for generating the first and second PWM signals PWM₁ and PWM₂. For example, the first PWM signal PWM₁ may be enabled at the first reference time t1, and the second PWM signal PWM₂ may be delayed by T−W₁ from the first reference time t1 and enabled. As a result, the second PWM signal PWM₂ may be delayed by T−W₁ from the first PWM signal PWM₁.

In addition, t3 denotes the second reference time, which may be a reference time or a start time for generating the third and fourth PWM signals PWM₃ and PWM₄. For example, the third PWM signal PWM₃ may be enabled at the second reference time t3, and the fourth PWM signal PWM₄ may be delayed by T−W₁ from the second reference time t3 and enabled. As a result, the fourth PWM signal PWM₄ may be delayed by T−W₁ from the third PWM signal PWM₃.

A difference between the first reference time t1 and the second reference time t3 may be determined based on the pulse width W₁. For example, the difference between the first reference time t1 and the second reference time t3 may be determined by comparing the pulse width W₁ and a threshold A. If the pulse width W₁ is equal to or less than the threshold A, the difference between the first reference time t1 and the second reference time t3 may correspond to two times the pulse width W₁. For example, the second reference time t3 may be determined as a time delayed by 2W₁ from the first reference time t1. If the pulse width W₁ is greater than the threshold A, the difference between the first reference time t1 and the second reference time t3 may correspond to the pulse width W₁. For example, the second reference time t3 may be determined as a time delayed by W₁ from the first reference time t1.

The threshold A may be determined based on the output period T and the number K of channels. For example, the threshold A may be set as a value (2T/K) obtained by dividing two times the output period T by the number K of channels. Since the number K of channels in FIG. 6B is 4, the threshold A is half of a period (e.g., T/2). In addition, since the duty ratio W₁/T in FIG. 6B is 1/5, the pulse width W₁ is T/5. Thus, since the pulse width W₁ is less than the threshold A, the difference between the first reference time t1 and the second reference time t3 may be determined as two times the pulse width W₁. For example, the second reference time t3 may be determined as a time delayed by 2T/5 corresponding to two times the pulse width W₁ from the first reference time t1. In other words, the third PWM signal PWM₃ may be delayed by 2T/5 from the first PWM signal PWM₁.

The first to fourth PWM signals PWM₁ to PWM₄ have the same output period T and the same pulse width W₁ but have a phase difference therebetween and are enabled at times different from each other. For example, the first and second PWM signals PWM₁ and PWM₂ may have a phase difference corresponding to the difference (T−W₁) between the output period T and the pulse width W₁. Likewise, the third and fourth PWM signals PWM₃ and PWM₄ may have a phase difference corresponding to the difference (T−W₁) between the output period T and the pulse width W₁. The first and third PWM signals PWM₁ and PWM₃ may have a variable phase difference therebetween according to the pulse width W₁.

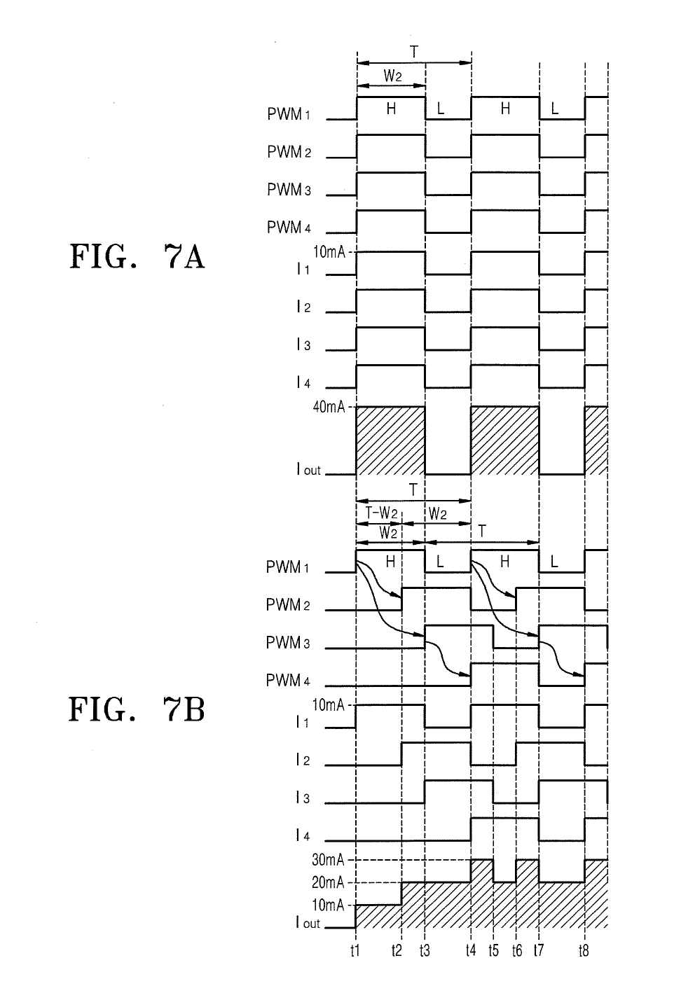

FIGS. 7A and 7B illustrate exemplary waveform diagrams where 4 loads are driven by PWM signals that have a duty ratio (W₂/T) of 3/5. FIG. 7A illustrates an exemplary where the simultaneous driving method is applied, and FIG. 7B illustrates an example where a driving method according to an exemplary embodiment of the inventive concept is applied. Hereinafter, it is assumed for convenience of description that first to fourth currents I₁ to I₄ that flow when first to fourth loads Load₁ to Load₄ are turned on (or activated) are 10 mA.

Referring to FIG. 7A, each of first to fourth PWM signals PWM₁ to PWM₄ output from the controller 120 has an output period T and a pulse width W₂. There is no phase difference between any two of the first to fourth PWM signals PWM₁ to PWM₄. Since waveforms of the control signals, namely, the first to fourth PWN signals PWM1 to PWM4, for respectively turning the first to fourth loads Load₁ to Load₄ on are the same, waveforms of the first to fourth currents I₁ to I₄ that respectively flow through the first to fourth loads Load₁ to Load₄ are also the same. For example, the first to fourth currents I₁ to I₄ that respectively flow through the first to fourth loads Load₁ to Load₄ are 10 mA in a time interval between t1 and t3 and 0 mA in a time interval between t3 and t4. The output current Iout of the power unit 110 is 40 mA in the time interval between t1 and t3 and 0 mA in the time interval between t3 and t4. Thus, a variation of the output current Iout in a time interval between t1 and t4 is +40 mA at t1 and −40 mA at t3. As a result, the maximum magnitude of the variation of the output current Iout during the single output period T is 40 mA.

Referring to FIG. 7B, each of the first to fourth PWM signals PWM₁ to PWM₄ output from the controller 120 has the output period T and the pulse width W₂. The first to fourth PWM signals PWM₁ to PWM₄ are enabled at times different from each other. Thus, the first to fourth PWM signals PWM₁ to PWM₄ have phases different from each other. There is a phase difference between the first and second PWM signals PWM₁ and PWM₂, which corresponds to T−W₂ (e.g., a difference between the output period T and the pulse width W₂). Since there is a phase difference corresponding to T−W₂ between waveforms of the control signals, namely, the first and second PWM signals PWM1 and PWM2, for respectively turning the first and second loads Load₁ and Load₂ on, there is also a phase difference corresponding to T−W₂ between waveforms of the first and second currents I₁ and I₂ that respectively flow through the first and second loads Load₁ and Load₂. For example, the first current I₁ that flows through the first load Load₁ is 10 mA in the time interval between t1 and t3 and 0 mA in the time interval between t3 and t4. The second current I₂ that flows through the second load Load₂ is 0 mA in a time interval between t1 and t2 and 10 mA in a time interval between t2 and t4. Each of the time intervals between t1 and t3 and the time intervals between t2 and t4 corresponds to the pulse width W₂. In addition, there is a phase difference between the third and fourth PWM signals PWM₃ and PWM₄, which corresponds to T−W₂ (e.g., a difference between the output period T and the pulse width W₂). Since there is a phase difference corresponding to T−W₂ between waveforms of the control signals, namely, the third and fourth PWM signals PWM3 and PWM4, for respectively turning the third and fourth loads Load₃ and Load₄ on, there is also a phase difference corresponding to T−W₂ between waveforms of the third and fourth currents I₃ and I₄ that respectively flow through the third and fourth loads Load₃ and Load₄. For example, the third current I₃ that flows through the third load Load₃ is 10 mA in a time interval between t3 and t5 and 0 mA in a time interval between t5 and t7. The fourth current I₄ that flows through the fourth load Load₄ is 0 mA in the time interval between t3 and t4 and 10 mA in a time interval between t4 and t7. Each of the time intervals between t3 and t5 and the time intervals between t4 and t7 corresponds to the pulse width W₂. The output current Iout of the power unit 110 is 10 mA in the time interval between t1 and t2, 20 mA in the time interval between t2 and t4, 30 mA in a time interval between t4 and t5, 20 mA in a time interval between t5 and t6, 30 mA in a time interval between t6 and t7, and 20 mA in a time interval between t7 and t8. Thus, a variation of the output current Iout of the power unit 110 in a time interval between t1 and t8 is +10 mA at t1, t2, t4, and t6 and −10 mA at t5 and t7. As a result, the maximum magnitude of the variation of the output current Iout during the single output period T is 10 mA. Thus, the maximum magnitude of the variation of the output current Iout is reduced by 75% as compared with the example of FIG. 7A where the simultaneous driving method is applied.

Here, t1 denotes the first reference time, which may be a reference time or a start time for generating the first and second PWM signals PWM₁ and PWM₂. For example, the first PWM signal PWM₁ may be enabled at the first reference time t1, and the second PWM signal PWM₂ may be delayed by T−W₂ from the first reference time t1 and enabled. As a result, the second PWM signal PWM₂ may be delayed by T−W₂ from the first PWM signal PWM₁.

In addition, t3 denotes the second reference time, which may be a reference time or a start time for generating the third and fourth PWM signals PWM₃ and PWM₄. For example, the third PWM signal PWM₃ may be enabled at the second reference time t3, and the fourth PWM signal PWM₄ may be delayed by T−W₂ from the second reference time t3 and enabled. As a result, the fourth PWM signal PWM₄ may be delayed by T−W₂ from the third PWM signal PWM₃.

A difference between the first reference time t1 and the second reference time t3 may be determined based on the pulse width W₂. For example, the difference between the first reference time t1 and the second reference time t3 may be determined by comparing the pulse width W₂ and the threshold A. If the pulse width W₂ is equal to or less than the threshold A, the difference between the first reference time t1 and the second reference time t3 may correspond to two times the pulse width W₂. For example, the second reference time t3 may be determined as a time delayed by 2W₂ from the first reference time t1. If the pulse width W₂ is greater than the threshold A, the difference between the first reference time t1 and the second reference time t3 may correspond to the pulse width W₂. For example, the second reference time t3 may be determined as a time delayed by W₂ from the first reference time t1.

The threshold A may be determined based on the output period T and the number K of channels. For example, the threshold A may be set as a value (2T/K) obtained by dividing two times the output period T by the number K of channels. Since the number K of channels in FIG. 7B is 4, the threshold A is half of a period (e.g., T/2). In addition, since the duty ratio W₂/T in FIG. 7B is 3/5, the pulse width W₂ is 3T/5. Thus, since the pulse width W₂ is greater than the threshold A, the difference between the first reference time t1 and the second reference time t3 may be determined as the pulse width W₂. For example, the second reference time t3 may be determined as a time delayed by 3T/5 corresponding to the pulse width W₂ from the first reference time t1. In other words, the third PWM signal PWM₃ may be delayed by 3T/5 from the first PWM signal PWM₁.

The first to fourth PWM signals PWM₁ to PWM₄ have the same output period T and the same pulse width W₂ but have a phase difference therebetween and are enabled at times different from each other. For example, the first and second PWM signals PWM₁ and PWM₂ have a phase difference corresponding to the difference (T−W₂) between the output period T and the pulse width W₂. Likewise, the third and fourth PWM signals PWM₃ and PWM₄ have a phase difference corresponding to the difference (T−W₂) between the output period T and the pulse width W₂. The first and third PWM signals PWM₁ and PWM₃ have a variable phase difference therebetween according to the pulse width W₂.

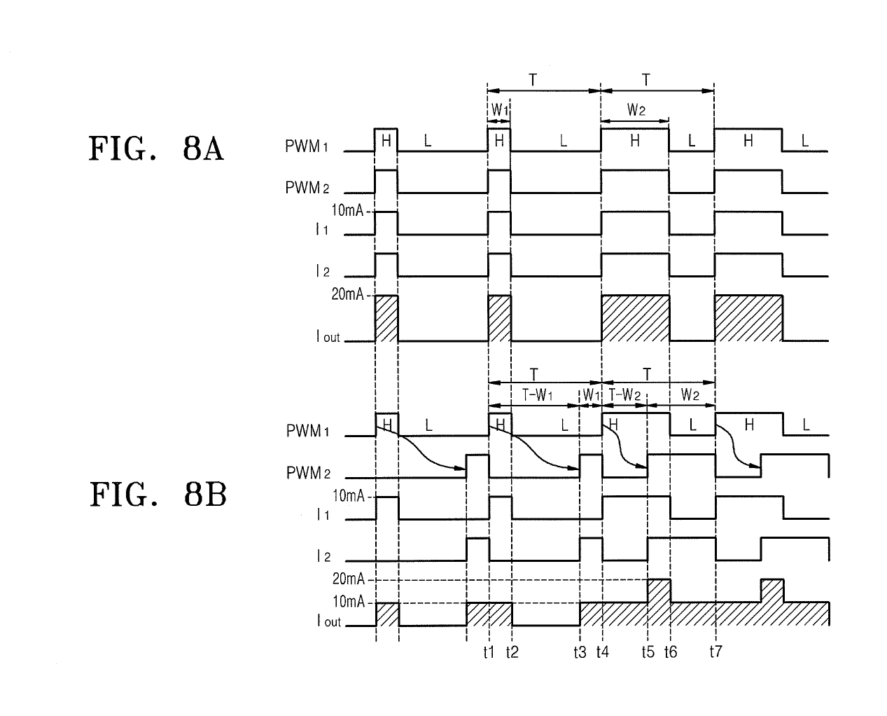

FIGS. 8A and 8B illustrate exemplary waveform diagrams where a duty ratio of PWM signals for driving 2 loads is changed from 1/5 to 3/5. FIG. 8A illustrates an example where the simultaneous driving method is applied, and FIG. 8B illustrates an example where a driving method according to an exemplary embodiment of the inventive concept is applied. Hereinafter, it is assumed for convenience of description that first and second currents I₁ and I₂ that flow when first and second loads Load₁ and Load₂ are turned on (or activated) are 10 mA.

Referring to FIG. 8A, each of first and second PWM signals PWM₁ and PWM₂ output from the controller 120 has an output period T and a pulse width W₁ in a time interval between t1 and t4 and the output period T and a pulse width W₂ in a time interval between t4 and t7. For example, the pulse width W₁ in the time interval between t1 and t4 is T/5, and the pulse width W₂ in the time interval between t4 and t7 is 3T/5. For example, the output period T is not changed while the pulse width W is changed at t4. There is no phase difference between the first and second PWM signals PWM₁ and PWM₂. Waveforms of the control signals, namely, the first and second PWM signals PWM1 and PWM2, for respectively turning the first and second loads Load₁ and Load₂ on are the same as waveforms of the first and second currents I₁ and I₂ that respectively flow through the first and second loads Load₁ and Load₂. Waveforms in the interval between t1 and t4 in which the pulse width is T/5 are similar to those of FIG. 2A, and waveforms in the time interval between t4 and t7 in which the pulse width is 3T/5 are similar to those of FIG. 3A.

Referring to FIG. 8B, each of the first and second PWM signals PWM₁ and PWM₂ output from the controller 120 has the output period T and the pulse width W₁ in the time interval between t1 and t4 and the output period T and the pulse width W₂ in the time interval between t4 and t7. For example, the pulse width W₁ in the time interval between t1 and t4 is T/5, and the pulse width W₂ in the time interval between t4 and t7 is 3T/5. For example, the output period T is not changed while the pulse width W is changed at t4. There is a phase difference between the first and second PWM signals PWM₁ and PWM₂, which corresponds to T−W₁ (e.g., a difference between the output period T and the pulse width W₁) in the time interval between t1 and t4, and there is a phase difference between the first and second PWM signals PWM₁ and PWM₂, which corresponds to T−W₂ (e.g., a difference between the output period T and the pulse width W₂) in the time interval between t4 and t7. As a result, waveforms in the interval between t1 and t4 in which the pulse width is T/5 are similar to those of FIG. 2B, and waveforms in the time interval between t4 and t7 in which the pulse width is 3T/5 are similar to those of FIG. 3B.

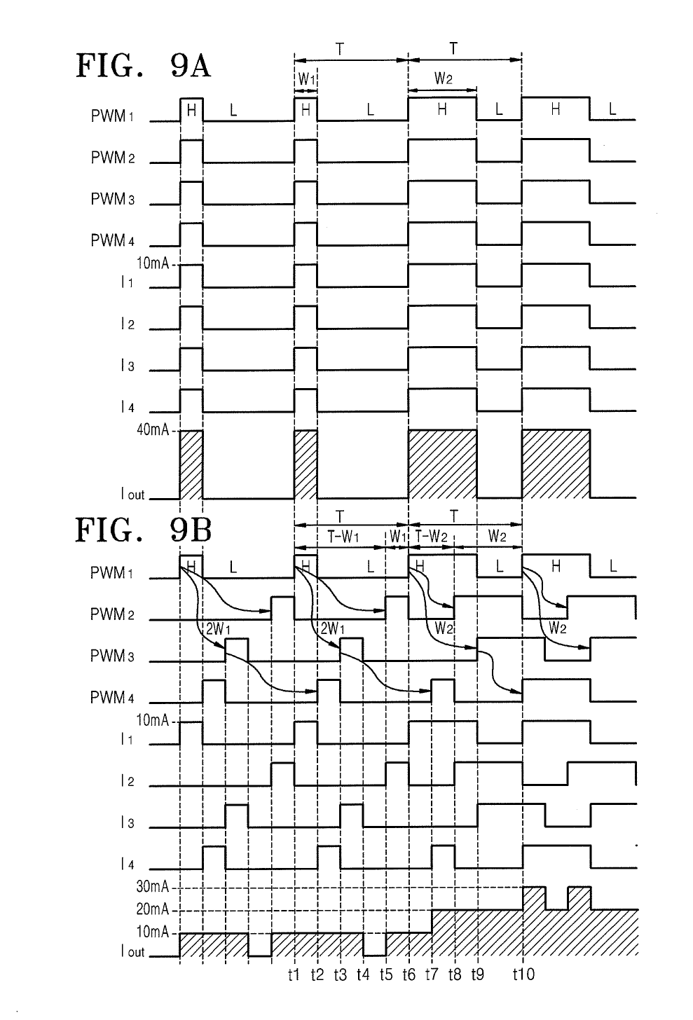

FIGS. 9A and 9B illustrate exemplary waveform diagram where a duty ratio of PWM signals for driving 4 loads is changed from 1/5 to 3/5. FIG. 9A illustrates an example where the simultaneously driving method is applied, and FIG. 9B illustrates an example where a driving method according to an exemplary embodiment of the inventive concept is applied. Waveforms of first to fourth currents I₁ to I₄ that respectively flow through the first to fourth loads Load₁ to Load₄ are the same as waveforms of control signals, namely, first to fourth PWM signals PWM1 to PWM4, for respectively turning the first to fourth loads Load₁ to Load₄ on. Hereinafter, it is assumed for convenience of description that the first to fourth currents I₁ to I₄ that flow when the first to fourth loads Load₁ to Load₄ are turned on (or activated) are 10 mA.

Referring to FIG. 9A, each of first to fourth PWM signals PWM₁ to PWM₄ output from the controller 120 has an output period T and a pulse width W₁ in a time interval between t1 and t6 and the output period T and a pulse width W₂ in a time interval between t6 and t10. For example, the pulse width W₁ in the time interval between t1 and t6 is T/5, and the pulse width W₂ in the time interval between t6 and t10 is 3T/5. For example, the output period T is not changed while the pulse width W is changed at t6. There is no phase difference between any two of the first to fourth PWM signals PWM₁ to PWM₄. As a result, waveforms in the interval between t1 and t6 in which the pulse width is T/5 are similar to those of FIG. 6A, and waveforms in the time interval between t6 and t10 in which the pulse width is 3T/5 are similar to those of FIG. 7A.

Referring to FIG. 9B, each of the first to fourth PWM signals PWM₁ to PWM₄ output from the controller 120 has the output period T and the pulse width W₁ in the time interval between t1 and t6 and the output period T and the pulse width W₂ in the time interval between t6 and t10. For example, the pulse width W₁ in the time interval between t1 and t6 is T/5, and the pulse width W₂ in the time interval between t6 and t10 is 3T/5. There is a phase difference between the first and second PWM signals PWM₁ and PWM₂, which corresponds to T−W₁ (e.g., a difference between the output period T and the pulse width W₁) in the time interval between t1 and t6 in which the pulse width W₁ is T/5, and there is a phase difference between the first and second PWM signals PWM₁ and PWM₂, which corresponds to T−W₂ (e.g., a difference between the output period T and the pulse width W₂) in the time interval between t6 and t10 in which the pulse width W₂ is 3T/5. Likewise, there is a phase difference between the third and fourth PWM signals PWM₃ and PWM₄, which corresponds to T−W₁ (e.g., the difference between the output period T and the pulse width W₁) in the time interval between t1 and t6 in which the pulse width W₁ is T/5, and there is a phase difference between the third and fourth PWM signals PWM₃ and PWM₄, which corresponds to T−W₂ (e.g., the difference between the output period T and the pulse width W₂) in the time interval between t6 and t10 in which the pulse width W₂ is 3T/5. There is a phase difference between the first and third PWM signals PWM₁ and PWM₃, which corresponds to 2W₁ (e.g., two times the pulse width W₁) in the time interval between t1 and t6 in which the pulse width W₁ is T/5, and there is a phase difference between the first and third PWM signals PWM₁ and PWM₃, which corresponds to W₂ (e.g., the pulse width W₂) in the time interval between t6 and t10 in which the pulse width W₂ is 3T/5. As a result, waveforms in the interval between t1 and t6 in which the pulse width is T/5 are similar to those of FIG. 6B, and waveforms in the time interval between t6 and t10 in which the pulse width is 3T/5 are similar to those of FIG. 7B. However, unlike the fourth PWM signal of FIG. 7B, the fourth PWM signal PWM₄ of FIG. 9B has a high pulse corresponding to the pulse width W₁ in a time interval between t7 and t8. This is caused by a high pulse of the third PWM signal PWM₃ corresponding to the pulse width W₁ in a time interval between t3 and t4, which is not considered in FIG. 7B.

Although an example where the output period T is changed is not illustrated in FIGS. 2 to 9, the output period T of a plurality of PWM signals generated according to an exemplary inventive concept may also be arbitrarily changed.

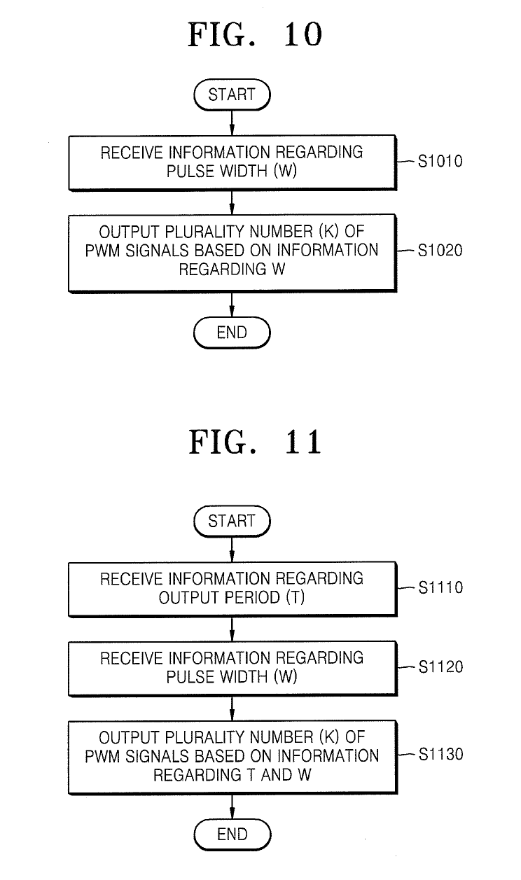

FIG. 10 is a flowchart illustrating a multi-channel PWM signal generating method according to an exemplary embodiment of the inventive concept. Referring to FIG. 10, the multi-channel PWM signal generating method may include receiving information regarding a pulse width W (operation S1010) and outputting a plurality of PWM signals based on the information regarding a pulse width W (operation S1020). The outputting of a plurality of PWM signals in operation S1020 may include outputting at least one pair of PWM signals that have a phase difference corresponding to a difference between an output period T and the pulse width W. For example, when 2 PWM signals PWM₁ and PWM₂ that have the output period T and the pulse width W are generated, the output signals PWM₁ and PWM₂ of first and second channels may have a phase difference of T−W therebetween. When 4 PWM signals PWM₁ to PWM₄ that have the output period T and the pulse width W are generated, the output signals PWM₃ and PWM₄ of third and fourth channels besides the output signals PWM₁ and PWM₂ of the first and second channels may also have the phase difference of T−W therebetween.

FIG. 11 is a flowchart illustrating a multi-channel PWM signal generating method according to an exemplary embodiment of the inventive concept. Referring to FIG. 11, the multi-channel PWM signal generating method may include receiving information regarding an output period T (operation S1110), receiving information regarding a pulse width W (operation S1120), and outputting a plurality of PWM signals based on the information regarding the output period T and the pulse width W (operation S1130). The outputting of a plurality of PWM signals in operation S1130 may include outputting at least one pair of PWM signals that have a phase difference corresponding to a difference between the output period T and the pulse width W. Unlike the embodiment of FIG. 10, the embodiment of FIG. 11 further includes receiving the information regarding an output period T. Thus, the output period T may be changed by a user.

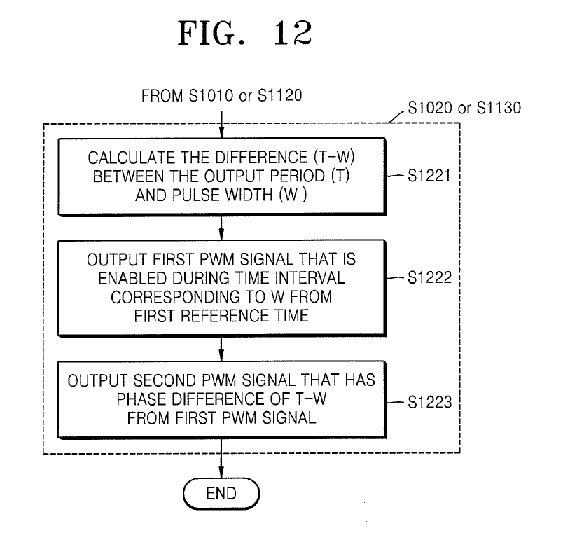

FIG. 12 is a flowchart illustrating the outputting of a plurality of PWM signals, according to an exemplary embodiment of the inventive concept. The method of FIG. 12 can be used as operation S1020 of FIG. 10 or as operation S1130 of FIG. 11. Referring to FIG. 12, the outputting of a plurality of PWM signals (e.g., operations S1020 and S1130 of FIGS. 10 and 11) may include calculating the difference (T−W) between the output period T and the pulse width W (operation S1221), outputting a first PWM signal PWM₁ at a first reference time (operation S1222), and outputting a second PWM signal PWM₂ (operation S1223). The first PWM signal PWM₁ may be enabled during a time interval corresponding to the pulse width W from the first reference time. The second PWM signal PWM₂ may have a phase difference of T−W from the first PWM signal PWM₁. For example, the second PWM signal PWM₂ may be delayed by T−W from the first PWM signal PWM₁.

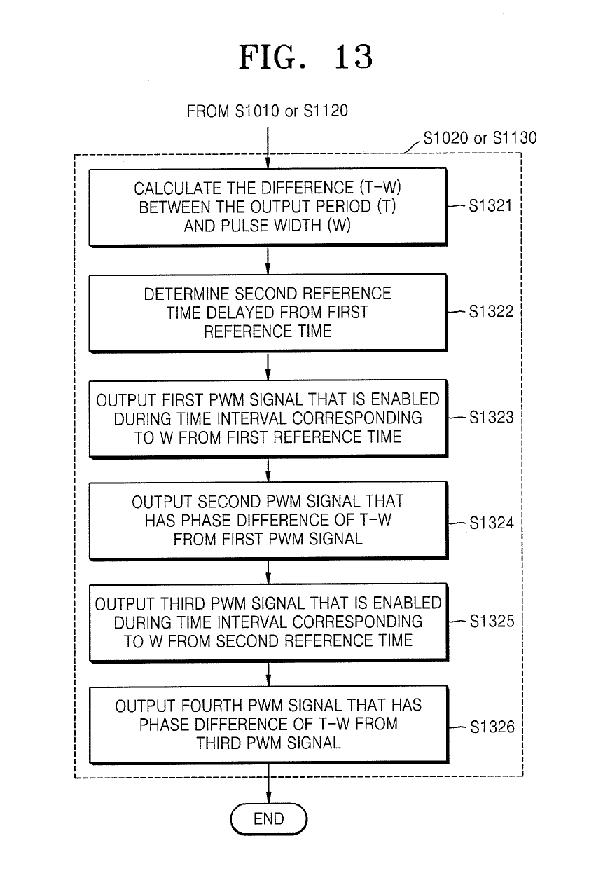

FIG. 13 is a flowchart illustrating the outputting of a plurality of PWM signals, according to an exemplary embodiment of the inventive concept. The method of FIG. 13 can be used as operation S1020 of FIG. 10 or as operation S1130 of FIG. 11. Referring to FIG. 13, the outputting of a plurality of PWM signals (e.g., operations S1020 and S1130 of FIGS. 10 and 11) may include calculating the difference (T−W) between the output period T and the pulse width W (operation S1321), determining a second reference time delayed from a first reference time (operation S1322), outputting a first PWM signal PWM₁ at the first reference time (operation S1323), outputting a second PWM signal PWM₂ (operation S1324), outputting a third PWM signal PWM₃ at the second reference time (operation S1325), and outputting a fourth PWM signal PWM₄ (operation S1326). The first reference time may be a reference time for generating the first and second PWM signals PWM₁ and PWM₂. The first reference time may be pre-defined according to a design specification. The first PWM signal PWM₁ may be enabled during a time interval corresponding to the pulse width W from the first reference time. The second PWM signal PWM₂ may have a phase difference of T−W from the first PWM signal PWM₁. The second reference time may be a reference time for generating the third and fourth PWM signals PWM₃ and PWM₄. The second reference time may be delayed from the first reference time. The third PWM signal PWM₃ may be enabled during a time interval corresponding to the pulse width W from the second reference time. The fourth PWM signal PWM₄ may have a phase difference of T−W from the third PWM signal PWM₃.

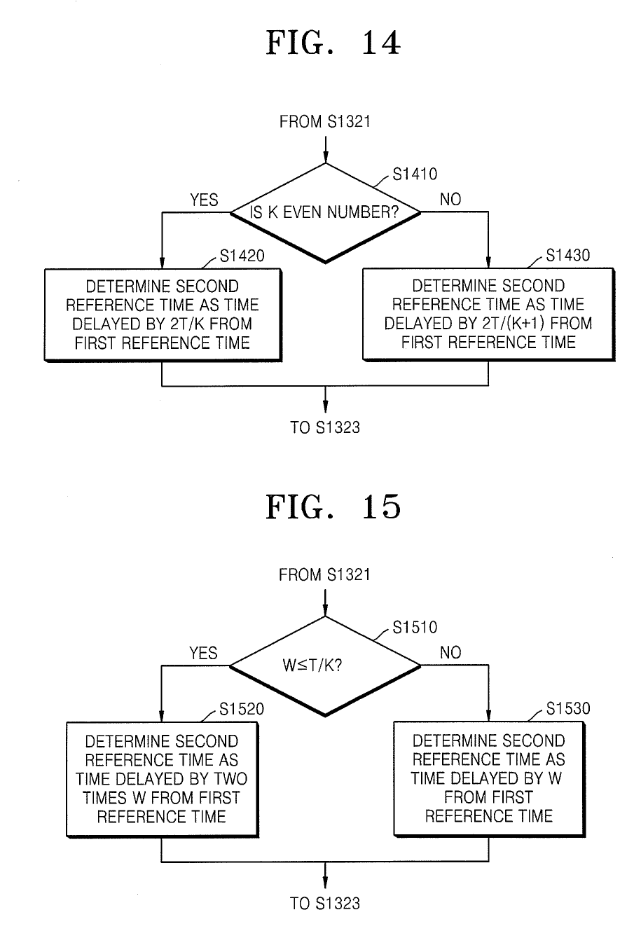

FIG. 14 is a flowchart illustrating the determining of the second reference time (e.g., operation S1322 of FIG. 13), according to an exemplary embodiment of the inventive concept. For example, FIG. 14 illustrates a method of determining the second reference time based on the number K of channels. Thus, the first and third PWM signals PWM₁ and PWM₃ may have a phase difference determined according to the number K of PWM signals to be output regardless of the pulse width W.

Referring to FIG. 14, the determining of the second reference time (e.g., operation S1322 of FIG. 13) may include checking whether the number K of channels is an even number (operation S1410), determining the second reference time when the number K of channels is an even number (operation S1420), and determining the second reference time when the number K of channels is an odd number (operation S1430). The determining of the second reference time when the number K of channels is an even number (operation S1420) may include determining the second reference time as a time delayed by 2T/K from the first reference time. For example, when the number K of channels is 4, the second reference time may be determined as a time delayed by T/2 from the first reference time. When the number K of channels is 6, the second reference time may be determined as a time delayed by T/3 from the first reference time.

The determining of the second reference time when the number K of channels is an odd number (operation S1430) may include determining the second reference time as a time delayed by 2T/(K+1) from the first reference time. For example, when the number K of channels is 3, the second reference time may be determined as a time delayed by T/2 from the first reference time. When the number K of channels is 5, the second reference time may be determined as a time delayed by T/3 from the first reference time.

FIG. 15 is a flowchart illustrating the determining of the second reference time (e.g., operation S1322 of FIG. 13), according to an exemplary embodiment of the inventive concept. For example, FIG. 15 illustrates a method of determining the second reference time based on the pulse width W (or duty ratio). Thus, the first and third PWM signals PWM₁ and PWM₃ may have a phase difference that varies according to the pulse width W (or duty ratio).

Referring to FIG. 15, the determining of the second reference time (e.g., operation S1322 of FIG. 13) may include comparing the pulse width W with a threshold A (operation S1510), determining the second reference time when the pulse width W is equal to or less than the threshold A (operation S1520), and determining the second reference time when the pulse width W is greater than the threshold A (operation S1530). The threshold A may be determined according to the number K of channels. For example, the threshold A may be a value obtained by dividing the output period T by the number K of channels. For example, when the number K of channels is 4, the threshold A may be T/4, and when the number K of channels is 6, the threshold A may be T/6. The determining of the second reference time when the pulse width W is equal to or less than the threshold A (operation S1520) may include determining the second reference time as a time delayed by two times the pulse width W from the first reference time. For example, when the number K of channels is 4 and the pulse width W is T/5, the pulse width W is less than the threshold A. Thus, the determining of the second reference time when the pulse width W is equal to or less than the threshold A (operation S1520) may include determining the second reference time as a time delayed by 2T/5 from the first reference time. The determining of the second reference time when the pulse width W is greater than the threshold A (operation S1530) may include determining the second reference time as a time delayed by the pulse width W from the first reference time. For example, when the number K of channels is 4 and the pulse width W is 3T/5, the pulse width W is greater than the threshold A. Thus, the determining of the second reference time when the pulse width W is greater than the threshold A (operation S1530) may include determining the second reference time as a time delayed by T/5 from the first reference time.

As described above, multi-channel PWM signal generating methods according to at least one embodiment of the inventive concept may stabilize levels of an output voltage and an output current for driving a plurality of loads by dividing the plurality of loads into a plurality of groups, performing time difference driving in each of the plurality of groups, and performing time difference driving between the plurality of groups. As a result, instability of the output voltage and the output current of a power unit, which may cause the life of each device to be reduced and an abnormal operation to occur, may be removed, which results in stable operation of a system.

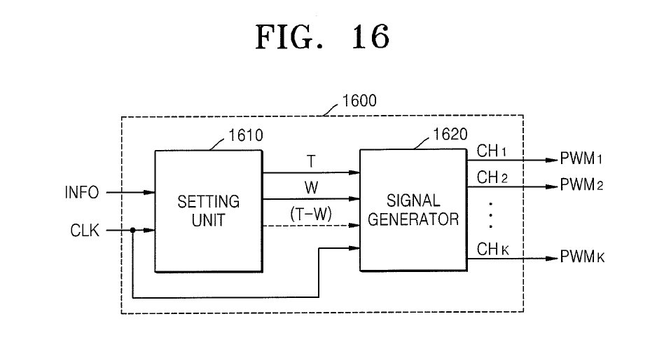

FIG. 16 is a block diagram of a multi-channel PWM signal generating apparatus 1600 according to an exemplary embodiment of the inventive concept. Referring to FIG. 16, the multi-channel PWM signal generating apparatus 1600 may include a setting unit 1610 and a signal generator 1620. The setting unit 1610 may receive a reference clock CLK and an interface signal INFO. The interface signal INFO may include information regarding a pulse width W. The setting unit 1610 may extract and store the information regarding a pulse width W which is included in the interface signal INFO. The setting unit 1610 may provide the information regarding a pulse width W to the signal generator 1620. The information regarding a pulse width W may be updated at every output period T. The setting unit 1610 may further receive information regarding an output period T. For example, the interface signal INFO may further include the information regarding an output period T. The setting unit 1610 may extract and store the information regarding an output period T when it is included in the interface signal INFO. The setting unit 1610 may calculate and store a difference (T−W) between the output period T and the pulse width W. The setting unit 1610 may include a register (not shown) for storing information derived from the interface signal INFO (e.g., the pulse width W, the output period T, the difference T−W, etc).

The signal generator 1620 may receive the information regarding a pulse width W from the setting unit 1610 and generate and output a plurality of PWM signals PWM₁ to PWMₖ. The signal generator 1620 may further receive the information regarding an output period T from the setting unit 1610. The signal generator 1620 may receive information regarding a difference (T−W) between the output period T and the pulse width W from the setting unit 1610. At least one pair of the plurality of PWM signals PWM₁ to PWMₖ output from the signal generator 1620 may have a phase difference corresponding to the difference (T−W) between the output period T and the pulse width W. For example, the phase difference may be T−W.

The setting unit 1610 may provide the output period T and the pulse width W to the signal generator 1620 without providing the phase difference. In this example, the signal generator 1620 may calculate the information regarding a difference (T−W) between the output period T and the pulse width W by itself using the received information regarding an output period T and a pulse width W. For example, the information regarding a difference (T−W) between the output period T and the pulse width W may be calculated by the setting unit 1610 or the signal generator 1620.

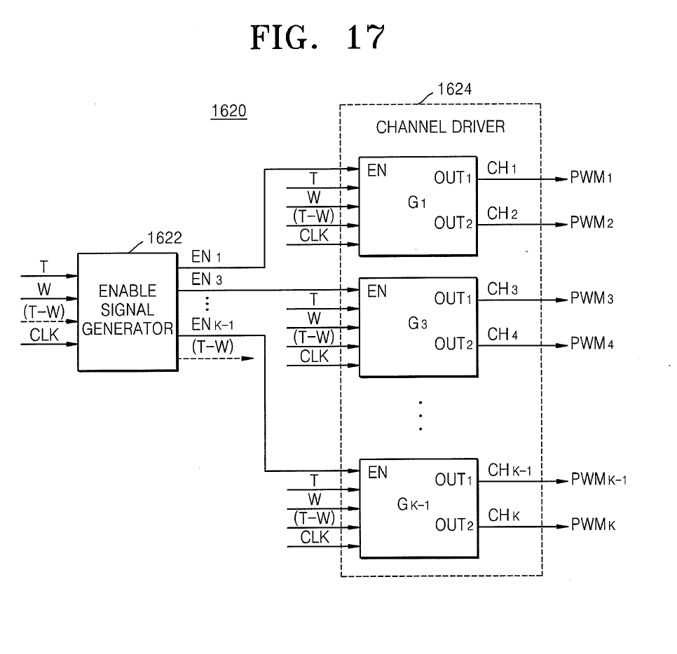

FIG. 17 is a block diagram of the signal generator 1620 of FIG. 16, according to an exemplary embodiment of the inventive concept. Referring to FIG. 17, the signal generator 1620 may include an enable signal generator 1622 and a channel driver 1624.

The enable signal generator 1622 may receive the information regarding a pulse width W from the setting unit 1610 of FIG. 16, calculate the information regarding a difference (T−W) between the output period T and the pulse width W, determine a plurality of reference times for generating the plurality of PWM signals PWM₁ to PWM_{K}, and output enable signals EN₁ to EN_{K-1} for activating corresponding channel groups at the plurality of reference times. In this example, the output period T may be predetermined according to a design specification.

Alternatively, the enable signal generator 1620 may receive the information regarding an output period T and the information regarding a pulse width W from the setting unit 1610 of FIG. 16, calculate the information regarding a difference (T−W) between the output period T and the pulse width W, determine a plurality of reference times for generating the plurality of PWM signals PWM₁ to PWM_{K}, and output enable signals EN₁ to EN_{K-1} for activating corresponding channel groups at the plurality of reference times. In this example, the output period T may be arbitrarily changed.

A PWM signal and another PWM signal of the plurality of PWM signals PWM₁ to PWM_{K} may form pairs to be generated and output based on the same reference time. For example, when 4 PWM signals are output, the plurality of PWM signals PWM₁ to PWM_{K} may be grouped as 2 channel groups G₁ and G₂, each group being formed with 2 PWM signals, and enable signals EN₁ and EN₃ for activating the 2 channel groups G₁ and G₂ may be output. When 5 PWM signals are output, the plurality of PWM signals PWM₁ to PWM_{K} may be grouped as 2 channel groups G₁ and G₂ (first to fourth PWM signals), each group being formed with 2 PWM signals, and a channel group G₃ formed with a single PWM signal (a fifth PWM signal), and enable signals EN₁, EN₃, and EN₅ for activating the 3 channel groups G₁ to G₃ may be output.

The enable signal generator 1622 may determine a phase difference between the plurality of reference times (e.g., a difference between a first reference time and a second reference time) as a predetermined value regardless of the pulse width W. For example, the enable signal generator 1622 may determine the difference between the plurality of reference times based on the number K of output channels. When the number K of output channels is an even number, the enable signal generator 1622 may determine the second reference time so that the difference between the first reference time and the second reference time is 2T/K. When the number K of output channels is an odd number, the enable signal generator 1622 may determine the second reference time so that the difference between the first reference time and the second reference time is 2T/(K+1).

The enable signal generator 1622 may determine a phase difference between the plurality of reference times (e.g., the difference between the first reference time and the second reference time) to vary according to the pulse width W. For example, the difference between the first reference time and the second reference time may be determined by comparing the pulse width W with a threshold A. If the pulse width W is equal to or less than the threshold A, the difference between the first reference time and the second reference time may be two times the pulse width W. For example, the enable signal generator 1622 may determine the second reference time as a time delayed by 2W from the first reference time. If the pulse width W is greater than the threshold A, the difference between the first reference time and the second reference time may be the pulse width W. For example, the enable signal generator 1622 may determine the second reference time as a time delayed by W from the first reference time.

The enable signal generator 1622 may determine the threshold A based on the output period T and the number K of channels. For example, the threshold A may be determined as a value (T/K) obtained by dividing the output period T by the number K of channels. For example, when the number K of channels is 4, the threshold A is T/4. Here, if a duty ratio (W/T) is 3/5, the pulse width W is 3T/5. Thus, since the pulse width W is greater than the threshold A, the enable signal generator 1622 may determine the difference between the first reference time and the second reference time to be the same as the pulse width W. For example, the enable signal generator 1622 may determine the second reference time as a time delayed by 3T/5 corresponding to the pulse width W from the first reference time.

As another example, when the number K of channels is 4, the threshold A is T/4. Here, if the duty ratio (W/T) is 1/5, the pulse width W is T/5. Thus, since the pulse width W is less than the threshold A, the enable signal generator 1622 may determine the difference between the first reference time and the second reference time as two times the pulse width W. For example, the enable signal generator 1622 may determine the second reference time as a time delayed by 2T/5 corresponding to two times the pulse width W from the first reference time.

The channel driver 1624 may include a plurality of group output units G₁ to G_{K-1}. Each of the group output units G₁ to G_{K-1} may generate and output a pair of PWM signals PWM_{K-1} and PWM_{K}. Hereinafter, an embodiment of where the signal generator 1620 generates and outputs 4 PWM signals PWM₁ to PWM₄ is described as an example. The channel driver 1624 may include a first group output unit G₁ and a second group output unit G₃. The first group output unit G₁ may generate and output first and second channel output signals PWM₁ and PWM₂. The first channel output signal PWM₁ may be enabled (or activated) at the first reference time, and the second channel output signal PWM₂ may be delayed by T−W₁ from the first reference time and enabled (or activated). The second group output unit G₃ may generate and output third and fourth channel output signals PWM₃ and PWM₄. The third channel output signal PWM₃ may be enabled (or activated) at the second reference time, and the fourth channel output signal PWM₄ may be delayed by T−W₁ from the second reference time and enabled (or activated).

As a result, the first to fourth channel output signals PWM₁ to PWM₄ generated and output by the signal generator 1620 may have the same output period T and the same pulse width W₁ but may have a phase difference therebetween and may be activated at times different from each other. In detail, the first and second channel output signals PWM₁ and PWM₂ may have a phase difference corresponding to a difference (T−W₁) between the output period T and the pulse width W₁. Likewise, the third and fourth channel output signals PWM₃ and PWM₄ may also have a phase difference corresponding to the difference (T−W₁) between the output period T and the pulse width W₁. The first and third channel output signals PWM₁ and PWM₃ may have a fixed phase difference determined based on the number K of channels or a variable phase difference determined based on the pulse width W₁.

Although an embodiment where the signal generator 1620 generates and outputs 4 PWM signals PWM₁ to PWM₄ through 4 channels CH₁ to CH₄ has been described as an example, the number of channels is not limited thereto, as there may be an arbitrary number of channels.

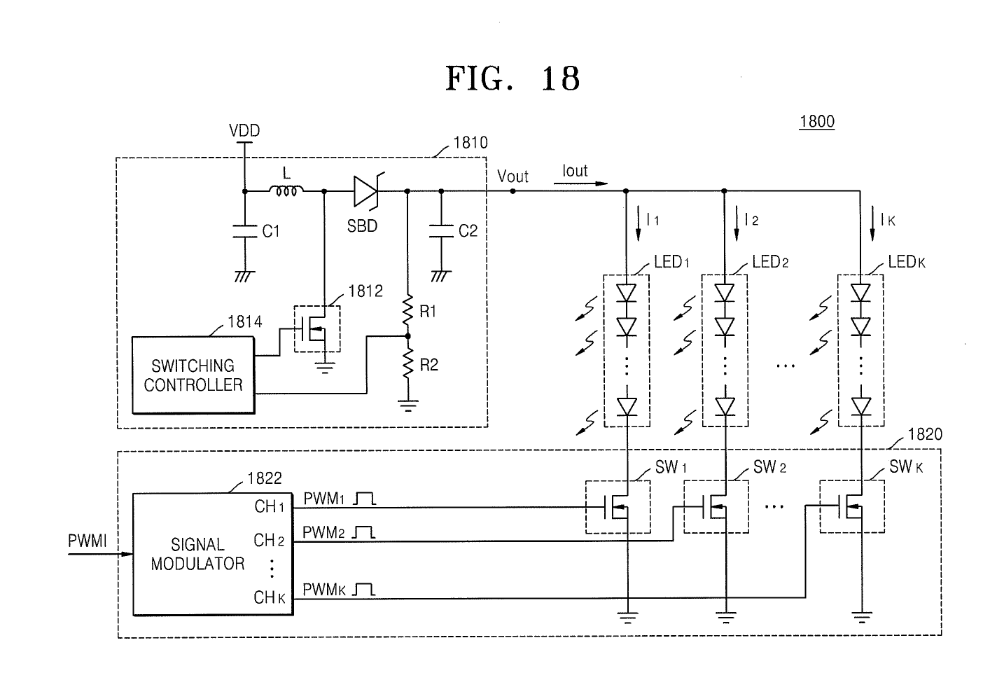

FIG. 18 is a diagram of an LED system 1800 according to an exemplary embodiment of the inventive concept. Referring to FIG. 18, the LED system 1800 may include a power unit 1810, an LED driver 1820, and a plurality of LED channels LED₁ to LED_{K}.

The power unit 1810 may include a transistor 1812, a switching controller 1814, an input capacitor C1, an inductor L, a Schottky Barrier Diode (SBD), resistors R1 and R2, and an output capacitor C2. The power unit 1810 may provide a DC voltage as an output voltage Vout to the plurality of LED channels LED₁ to LED_{K}. The power unit 1810 may be a DC-DC converter for converting an input voltage VDD into the output voltage Vout. The output voltage Vout may have a higher voltage level than the input voltage VDD. The switching controller 1814 may control turning ON/OFF of the transistor 1812. A signal output from the switching controller 1814 may be a PWM signal.

Each of the plurality of LED channels LED₁ to LED_{K} may include a plurality of LEDs connected in series or in a combination of in series and parallel. To increase uniformity of currents that flow through the plurality of LED channels LED₁ to LED_{K}, each of the plurality of LED channels LED₁ to LED_{K} may have the same configuration with the same number of LEDs that have the same characteristics. Each of the LEDs may be a white LED or a package LED in which a red (R) LED, a green (G) LED, and a blue (B) LED are packaged. Unlike an embodiment where only the white LED is used, in an embodiment where the RGB LEDs are used, since luminance characteristics between the RGB LEDs are different to each other, separate LED drivers for RGB colors may be required.

A plurality of switches SW₁ to SW_{K} may be periodically turned on/off in response to a plurality of PWM signals PWM₁ to PWM_{K}. The luminance of each of the plurality of LED channels LED₁ to LED_{K} may be proportional to a turn-on time of a corresponding switch. The plurality of switches SW₁ to SW_{K} may be high-power switches (e.g., Lateral Double-diffused Metal Oxide Semiconductor (LDMOS) switches).

The LED driver 1820 may drive the plurality of LED channels LED₁ to LED_{K} in a PWM scheme. The PWM scheme of the LED driver 1820 adjusts a pulse width or a duty ratio of a square wave to adjust the luminance of each of the plurality of LED channels LED₁ to LED_{K}. A mean current may vary according to duty ratios (e.g., widths) of current pulses that flow through the plurality of LED channels LED₁ to LED_{K}. Each of the widths of the current pulses indicates a time for a current to flow through a corresponding LED channel. The LED driver 1820 may change pulse widths or duty ratios of the plurality of PWM signals PWM₁ to PWM_{K} to adjust the luminance of each of the plurality of LED channels LED₁ to LED_{K}. Each of the duty ratios of the plurality of PWM signals PWM₁ to PWM_{K} is defined by a ratio of a pulse width W to an output period T of a corresponding PWM signal. Since an LED may perform an ON/OFF switching operation more quickly than other optical devices, the luminance of the LED may be controlled by adjusting a pulse width (or a duty ratio). Since the luminance of the LED is directly associated with or based on a current that flows through the LED, a PWM luminance control may be achieved by adjusting a mean current that flows through the LED. For example, as a pulse width or duty ratio of each PWM signal increases, a time for a current to flow through a corresponding LED increases, thereby increasing a mean current, which results in an increase in the luminance of the LEDs. However, as a pulse width or duty ratio of each PWM signal decreases, a time for a current to flow through a corresponding LED decreases, thereby decreasing a mean current, which results in a decrease in the luminance of the LEDs. The LED driver 1820 may include a signal modulator 1822 and the plurality of switches SW₁ to SW_{K}. The signal modulator 1822 may generate signals to be provided to the plurality of PWM signals PWM₁ to PWM_{K} and output the plurality of PWM signals PWM₁ to PWM_{K} through a plurality of channels CH₁ to CH_{K}. The plurality of switches SW₁ to SW_{K} may be turned on/off in response to the plurality of PWM signals PWM₁ to PWM_{K} output from the signal modulator 1822. The signal modulator 1822 may receive luminance information and generate and output the plurality of PWM signals PWM₁ to PWM_{K}. The luminance information may include information regarding a pulse width W of the plurality of PWM signals PWM₁ to PWM_{K} to be generated. The luminance information may further include information regarding an output period T of the plurality of PWM signals PWM₁ to PWM_{K} to be output. The luminance information may be received through a Pulse Width Modulation Interface (PWMI) (not shown). In this example, the signal modulator 1822 may detect and store a period and a pulse width of an input PWM signal by using a reference clock. The signal modulator 1822 may appropriately disperse turn-on timings of the plurality of switches SW₁ to SW_{K} to prevent a sudden change of the output current Iout of the power unit 1810. The signal modulator 1822 may be embodied by the multi-channel PWM signal generating apparatus 1600 of FIG. 16.

The plurality of switches SW₁ to SW_{K} may be periodically turned on/off in response to the plurality of PWM signals PWM₁ to PWM_{K} that have the output period T and the pulse width W. The luminance of the plurality of LED channels LED₁ to LED_{K} may be determined according to the mean current, which may be adjusted by the pulse width (or the duty ratio) of the plurality of PWM signals PWM₁ to PWM_{K}. Although the switching controller 1814 is included in the power unit 1810 in FIG. 18, the LED driver 1820 may include the switching controller 1814. For example, LED driver together with the switching controller may be implemented on a single semiconductor chip.

The LED system 1800 may provide uniform light intensity with high uniformity of the currents that flow through the plurality of LED channels LED₁ to LED_{K}. In addition, when the PWMI is used, since the luminance information is received through a single line PWMI, wiring complexity may be reduced, and the influence of Electromagnetic Interference (EMI) may be minimized. Since the luminance information is received by using a PWM signal in a form of a square wave, complexity of a circuit configuration of the LED system 1800 may be reduced, complexity of a manufacturing process thereof may be reduced, a size thereof may be reduced, and manufacturing costs thereof may be reduced.

Although at least one of the multi-channel time difference driving methods according to an exemplary embodiment of the inventive concept has been described with respect to a certain number of channels and duty ratios, the number of applicable channels and applicable duty ratios are not limited to the above-described examples and may be applied to an arbitrary number of channels and arbitrary duty ratios. In addition, in the multi-channel time difference driving method according to the exemplary embodiment of the inventive concept, a phase difference between channels may vary at every period according to received luminance information regardless of the number of channels. An output of each channel may be determined by referring to the received luminance information. The luminance information may be received through the PWMI. In this example, since a pulse width or a duty ratio of an input PWM signal may vary at every period, the phase difference between channels may also vary at every period.

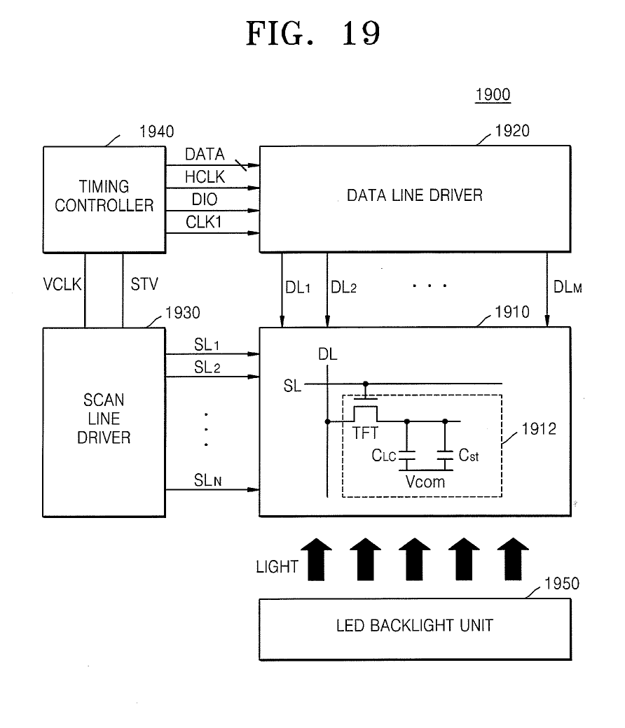

FIG. 19 is a block diagram of a Liquid Crystal Display (LCD) device 1900 according to an exemplary embodiment of the inventive concept. Referring to FIG. 19, the LCD device 1900 may include a liquid crystal panel 1910, a data line driver 1920, a scan line driver 1930, a timing controller 1940, and an LED backlight unit 1950. The data line driver 1920 may include a plurality of data driver Integrated Chips (ICs) (not shown). The scan line driver 1930 may include a plurality of scan driver ICs (not shown). Since the LCD device 1900 cannot emit light by itself and only displays an image by adjusting a transmission rate of light, the LCD device 1900 requires a separate light source. The LCD device 1900 may include the LED backlight unit 1950 as the light source. Thus, the LCD device 1900 may display an image by disposing the LED backlight unit 1950 on the back side of the liquid crystal panel 1910, projecting light emitted from the LED backlight unit 1950 on the liquid crystal panel 1910, and adjusting an amount of light transmitted according to the arrangement of liquid crystals. The LED backlight unit 1950 may be environmentally friendly, may have a high response speed (e.g., responds within nanoseconds), and may perform impulsive driving. The LED backlight unit 1950 may be embodied by the LED system 1800 of FIG. 18 as an example.

The liquid crystal panel 1910 may include a plurality of scan lines SL₁ to SL_{N} that extend in one direction and a plurality of data lines DL₁ to DL_{N} that extend in a direction different to that of the plurality of scan lines SL₁ to SL_{N}, and may include a pixel area 1912 near to where a scan line SL and a data line DL cross each other. In the pixel area 1912, a unit pixel including a Thin Film Transistor (TFT), a liquid crystal capacitor C_{LC}, and a storage capacitor C_{ST} may be disposed. The TFT may be turned on/off according to a driving signal applied to the scan line SL, and when the TFT is turned on, the TFT may provide an analog gradation signal supplied through the data line DL to a pixel electrode, thereby changing an electric field between both terminals of the liquid crystal capacitor C_{LC}. Accordingly, the arrangement of a liquid crystal (not shown) may be changed, thereby adjusting the transmission rate of light provided by the LED backlight unit 1950.

The timing controller 1940 may receive an image signal (e.g., pixel data (R, G, and B)) and control signals (e.g., a horizontal synchronization signal Hsync, a vertical synchronization signal Vsync, a main clock CLK, and a data enable signal DE) from an external graphic controller (not shown). The timing controller 1940 may process the pixel data (R, G, and B) to meet an operational condition of the liquid crystal panel 1910, generate a control signal for the scan line driver 1930 and a control signal for the data line driver 1920, and transmit the respective control signals to the scan line driver 1930 and the data line driver 1920. The control signal for the scan line driver 1930 may include a vertical start signal STV for directing that output of a gate turn-on voltage Gon start, a gate clock signal VCLK, and an output enable signal OE for controlling a period of the gate turn-on voltage Gon. The control signal for the data line driver 1920 may include a horizontal start signal DIO for indicating a transmission start of pixel data DATA, an output control signal CLK1 for controlling an analog gradation signal to be applied through a corresponding data line DL, and a clock signal HCLK.

A driving voltage generator (not shown) generates various driving voltages that may be used to drive the liquid crystal panel 1910 by using an external power input from an external power device (not shown). The driving voltage generator may receive a first power signal from the outside to generate second power signal to be provided to the data line driver 1920, the gate turn-on voltage Gon and a gate turn-off voltage Goff provided to the scan line driver 1930, and a common voltage Vcom provided to the liquid crystal panel 1910.

The scan line driver 1930 may apply the gate on/off voltage Gon/Goff of the driving voltage generator to a corresponding scan line SL in response to the vertical start signal STV, the gate clock signal VCLK, and the output enable signal OE received from the timing controller 1940. The gate on voltage Gon may turn the TFT on to apply an analog gradation voltage output from the data line driver 1920 to a corresponding pixel.

The data line driver 1920 may generate an analog gradation signal corresponding to digital image data and apply the analog gradation signal to a data line DL of the liquid crystal panel 1910, in response to the control signal for the data line driver 1920 received from the timing controller 1940.

When the LCD device 1900 includes the LED backlight unit 1950, the device 1900 may have a higher color reproducibility, be lighter, thinner, and smaller. In addition, as compared with existing light sources, the LCD device 1900 may have save more energy saving and last longer.

While the inventive concept has been particularly shown and described with reference to exemplary embodiments thereof, it will be understood that various changes in form and details may be made therein without departing from the spirit and scope of the disclosure.

What is claimed is:

1. A multi-channel Pulse Width Modulation (PWM) signal generating method comprising:
receiving information comprising a pulse width; and
outputting a plurality of PWM signals based on the pulse width,
wherein the outputting comprises outputting at least one pair of PWM signals that have a phase difference corresponding to a difference between an output period and the pulse width.

2. The multi-channel PWM signal generating method of claim 1, wherein the outputting comprises outputting the at least one pair of PWM signals and a second pair of PWM signals in respective reference times different from each other and such that an on-pulse of a PWM signal of the second pair is delayed relative to an on-pulse of a PWM signal of the first pair.

3. The multi-channel PWM signal generating method of claim 1, wherein the outputting comprises:
outputting a first PWM signal that is enabled during a time interval corresponding to the pulse width beginning at a first reference time; and
outputting a second PWM signal that has the phase difference from the first PWM signal.

4. The multi-channel PWM signal generating method of claim 3, wherein the outputting further comprises outputting a third PWM signal that is enabled during a time interval corresponding to the pulse width beginning at a second reference time different from the first reference time.

5. The multi-channel PWM signal generating method of claim 4, wherein the outputting further comprises determining the second reference time based on the number of plurality of PWM signals.

6. The multi-channel PWM signal generating method of claim 4, wherein the outputting further comprises determining the second reference time based on the pulse width.

7. The multi-channel PWM signal generating method of claim 6, wherein a difference between the first reference time and the second reference time corresponds to two times the pulse width when the pulse width is equal to or less than a threshold and corresponds to the pulse width when the pulse width is greater than the threshold.

8. The multi-channel PWM signal generating method of claim 7, wherein the threshold is a value obtained by dividing the output period by the number of plurality of PWM signals.

9. The multi-channel PWM signal generating method of claim 6, wherein the outputting further comprises outputting a fourth PWM signal that has the phase difference from the third PWM signal.

10. A multi-channel PWM signal generating apparatus comprising:
a setting unit for receiving information comprising a pulse width; and
a signal generator for outputting a plurality of PWM signals based on the pulse width,
wherein the signal generator outputs at least one pair of PWM signals that have a phase difference corresponding to a difference between an output period and the pulse width.

11. The multi-channel PWM signal generating apparatus of claim 10, wherein the signal generator outputs the at least one pair of PWM signals and a second pair of PWM signals in respective reference times different from each other and such that an on-pulse of a PWM signal of the second pair is delayed relative to an on-pulse of a PWM signal of the first pair.

12. The multi-channel PWM signal generating apparatus of claim 10, wherein the signal generator comprises:
an enable signal generator for determining at least one reference time; and
a channel driver for outputting a first PWM signal that is enabled during a time interval corresponding to the pulse width beginning at a first reference time and a second PWM signal that has the phase difference from the first PWM signal.

13. The multi-channel PWM signal generating apparatus of claim 12, wherein the channel driver outputs a third PWM signal that is enabled during a time interval corresponding to the pulse width beginning at a second reference time different from the first reference time.

14. The multi-channel PWM signal generating apparatus of claim 13, wherein the enable signal generator determines the second reference time based on the number of plurality of PWM signals.

15. The multi-channel PWM signal generating apparatus of claim 13, wherein the enable signal generator determines the second reference time based on the pulse width.

16. A driving system comprising:
a plurality of circuit loads;
a power unit providing an output voltage to each circuit load;
a plurality of switches, wherein each corresponding one of the switches is connected between a respective one of the circuit loads and ground;
a controller that outputs a signal comprising an on-period and an off-period to each switch, wherein during the on-period the corresponding load is activated and during the off-period the load is deactivated; and
a controller that receives a pulse width and outputs the signals having an on-pulse with the pulse width and such that the first and second signals have a phase difference therebetween based on the received pulse width.

17. The driving system of claim 16, wherein controller further receives a period and the controller outputs the signals to have a period that is substantially the same as the received period and such that the phase difference is a difference between the period and the pulse width.

18. The driving system of claim 16, wherein the loads and the signals number at least four, wherein the controller outputs the third and fourth signals to have a phase difference therebetween based on the received pulse width, and an on-pulse of the third signal is delayed relative to an on-pulse of the first signal by a delay period.

19. The driving system of claim 18, wherein the controller stores a threshold value, the controller sets the delay period to twice the received pulse width when the pulse width is ≦the threshold value and sets the delay period to the pulse width otherwise.

20. The driving system of claim 19, wherein the signals have substantially the same signal period and the threshold is obtained by dividing the signal period by the number of the signals.
